(19) United States
(12) Patent Application Publication
(10) Pub. No.: US 2016/0255397 A1
(43) Pub. Date: Sep. 1, 2016

(54) CONTEXTUALLY AWARE MANAGEMENT OF RESOURCES

(71) Applicant: Microsoft Technology Licensing, LLC, Redmond, WA (US)

(72) Inventors: Thomas A. Langan, Seattle, WA (US); Dan E. Walther, Redmond, WA (US); Ying Hao, Sammamish, WA (US); Joseph Chauvin, Sammamish, WA (US); Shailendra Mishra, Kenmore, WA (US); Nitin Rathee, Bothell, WA (US); Ashley C. Speicher, Redmond, WA (US); Cory J. Healey, Kirkland, WA (US); Nicholas J. Fang, Redmond, WA (US)

(73) Assignee: Microsoft Technology Licensing, LLC

(21) Appl. No.: 14/634,666

(22) Filed: Feb. 27, 2015

(51) Int. Cl. H04N 21/4335; H04N 21/4147; H04N 21/462; H04N 21/433; H04N 5/765; H04N 7/173; H04N 21/432; H04N 21/258; H04N 5/85

(52) U.S. Cl. CPC H04N 21/4335; H04N 21/25891; H04N 21/4147; H04N 21/4622; H04N 5/85; H04N 5/765; H04N 7/17318; H04N 21/4325; H04N 21/4334

(57) ABSTRACT

Technologies are described herein for providing contextually aware management of resources. Recorded content items are deleted from or added to a storage device depending on the availability of alternate resources sharing the content items and/or other contextual information. For example, if a storage device of a DVR has reached a threshold with respect to a storage capacity and/or other conditions develop, configurations disclosed herein analyze the content items stored in the DVR to determine if the content items are provided by an on-demand resource. If one or more stored content items are available on at least one on-demand resource, the system may delete the one or more content items from the DVR and generate a link to access the one or more content items from the on-demand resource. The link and a description of the one or more content items may then be added to the cross-platform programming playlist.

### BACKGROUND

Television viewers can access multiple channels that present a variety of content throughout the day and week. However, given the current broadcast distribution model, content is generally pre-scheduled. Thus, users often must wait for content of interest to become available for consumption. To address this issue, digital video recorders (DVRs) were introduced to provide time-shifted content viewing, which allows users to record a show or a series of shows and watch the recorded content at a desired time. With the introduction of DVRs, users are given a somewhat greater degree of consumer control with respect to content viewing.

Although DVRs allow users to time-shift television programming, existing systems are limited in a number of ways. For instance, existing DVRs have a fixed amount of storage space. When a DVR reaches its storage capacity with recorded content, some existing systems randomly delete selected content or the oldest content to allocate space for new content. Such techniques may lead to less than desirable results as they may not align with a user's intent, and further, some content may not be easy to replace.

It is with respect to these and other considerations that the disclosure made herein is presented.

### SUMMARY

Technologies are described herein for providing contextually aware management of resources. Utilizing the technologies described herein, contextual information is aggregated from a number of devices and/or resources. The contextual information may include data describing user activity, user subscriptions, user preferences and/or other information. The contextual information may also describe the capabilities and/or a status of one or more devices. According to some configurations, recorded content items are deleted from or added to a storage device depending on the availability of alternate resources sharing the content items and/or other contextual information. For example, if a storage device of a DVR and/or a server has reached a threshold with respect to a storage capacity and/or other conditions develop, configurations disclosed herein analyze the content items stored by the storage device to determine if the content items are provided by an on-demand resource, such as Netflix. Configurations disclosed herein may also determine that one or more recordings are to be deleted or added based on other changed conditions or other scenarios.

If one or more stored content items are available on at least one on-demand resource, the system may cause a computer to delete at least one content item from one or more storage devices. One or more computers obtain a link to access the content item from at least one on-demand resource. In some configurations, the link may be integrated into an existing program listing of a deleted content item.

In some configurations, content items may be added to or deleted from a storage device depending on contextual information and/or the availability of content items on one or more resources sharing the content items. For example, if a preference setting indicates that a user prefers to view content that allows for the mitigation of commercials, the system may provide a link to an on-demand resource or record content data from the broadcast resource based on consumption preferences and/or circumstances related to one or more devices and/or accounts. It can be appreciated that techniques provided herein may replace a link to on-demand content items with a link to recorded data as well. For example, based on preferences indicating a desire to have a better viewing experience, and based on storage space and tuner availability, once a program becomes available on a broadcast resource, the system may record the content item from a broadcast source and then replace a link of on-demand content. Thus, techniques described herein may add content to a storage device, such as the DVR. Such features allows the techniques disclosed herein to process preferences and other information regarding devices and components, which may indicate a desire to trade off storage space for other benefits.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing several example components of a system for providing contextually aware management of resources.

FIG. 2 is a screen diagram showing an illustrative graphical user interface that displays data relating to preferences used in techniques described herein.

FIGS. 3A and 3B illustrate examples of two graphical user interfaces that may be used to select one or more content items.

FIG. 4A is a screen diagram of an illustrative graphical user interface that displays information relating to a playlist.

FIG. 4B is a screen diagram of the graphical user interface shown in FIG. 4A with updated status information.

FIG. 5A is a screen diagram showing an illustrative graphical user interface that displays information relating to a playlist having recorded video data and linked video data.

FIG. 5B is a screen diagram showing an illustrative graphical user interface that displays information relating to a playlist having recorded video data, linked video data and updated source information.

FIG. 6 is a flow diagram showing aspects of a routine disclosed herein for providing contextually aware aggregation of cross-platform media programming.

FIG. 7 is a flow diagram showing aspects of a routine disclosed herein for managing a storage device.

FIG. 8 is a computer architecture diagram illustrating an illustrative computer hardware and software architecture for a computing system capable of implementing aspects of the techniques and technologies presented herein.

FIG. 9 is a diagram illustrating a distributed computing environment capable of implementing aspects of the techniques and technologies presented herein.

FIG. 10 is a computer architecture diagram illustrating a computing device architecture for a computing device capable of implementing aspects of the techniques and technologies presented herein.

### DETAILED DESCRIPTION

The following detailed description is directed to concepts and technologies for providing contextually aware management of resources. Utilizing the technologies described herein, contextual information is aggregated from a number of devices and/or resources. The contextual information may include data describing user activity, user subscriptions, user preferences and/or other information. The contextual information may also describe the capabilities and/or a status of one or more devices. According to some configurations, recorded content items are deleted from or added to a storage device depending on the availability of alternate resources sharing the content items and/or other contextual information. For example, if a storage device of a DVR and/or a server has reached a threshold with respect to a storage capacity and/or other conditions develop, configurations disclosed herein analyze the content items stored by the storage device to determine if the content items are provided by an on-demand resource, such as NETFLIX. Configurations disclosed herein may also determine that one or more recordings are to be deleted or added, e.g., schedule for recording, based on other changed conditions or other scenarios.

If one or more stored content items are available on at least one on-demand resource, the system may cause a computer to delete at least one content item from one or more storage devices. One or more computers obtain a link to access the content item from at least one on-demand resource. In some configurations, the link may be integrated into an existing program listing of a deleted content item.

By the use of contextual data from one or more resources, content items may be selected for deletion when alternative content is available. Users may be able to store more content on a device by removing items that are replaceable. As will be described in more detail herein, the system may utilize a number of factors to determine if alternative content is available. For example, the system may determine that alternative content is available if a particular content item meets one or more thresholds and/or conditions related to video quality, video format, available delivery methods and/or other features. In some configurations, based on one or more consumption preferences and/or other factors, the system may determine that an alternative source for a content item is not suitable if the delivery involves commercials or does not have the ability to fast-forward through commercials. Techniques described herein reduce problems that are created by systems that automatically remove randomly selected content. In addition, when recorded content items are removed from a storage device, instead of deleting the content item from a playlist, the system updates the playlist allowing users to access the content items from the alternative resource using the existing listing.

As described in the examples provided herein, the utilization of the contextual data provides a number of benefits. In addition to preserving resources, such as storage space on a DVR, the use of the contextual data allows the system to process preferences and other information related to system components, which may indicate a desire to trade off storage space for other benefits. The use of the contextual data may also provide some benefit in optimizing the use of other devices and components, such as the tuner. In addition, the use of the contextual data including one or more preferences may allow the system to enhance a user's viewing experience, e.g., an automatic selection of a resource that mitigates the appearance of commercials. In such scenarios, based on the user preference and/or a number of factors derived from the contextual data, the system may provide a link to content of an on-demand resource or record content data from a broadcast resource. Such techniques may be based on consumption preferences and/or circumstances related to one or more devices and/or accounts. It can be appreciated that techniques provided herein may replace a link to on-demand content items with a link to recorded data as well. For example, based on preferences indicating a desire to have a better viewing experience, and based on storage space and tuner availability, once a program becomes available on a broadcast resource, the system may record the content item from a broadcast source and then replace a link of on-demand content. Thus, techniques described herein may add content to a storage device, such as the DVR.

While the subject matter described herein is primarily presented in the general context of techniques for providing contextually aware management of resources, it can be appreciated that the techniques described herein may apply to any type of data regardless of the type of computer or service that is storing or sharing the data. For instance, audio files, images and other types of data communicated and managed via streaming services, peer-to-peer arrangements or other architectures may also utilize the techniques and technologies described herein.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers and the like.

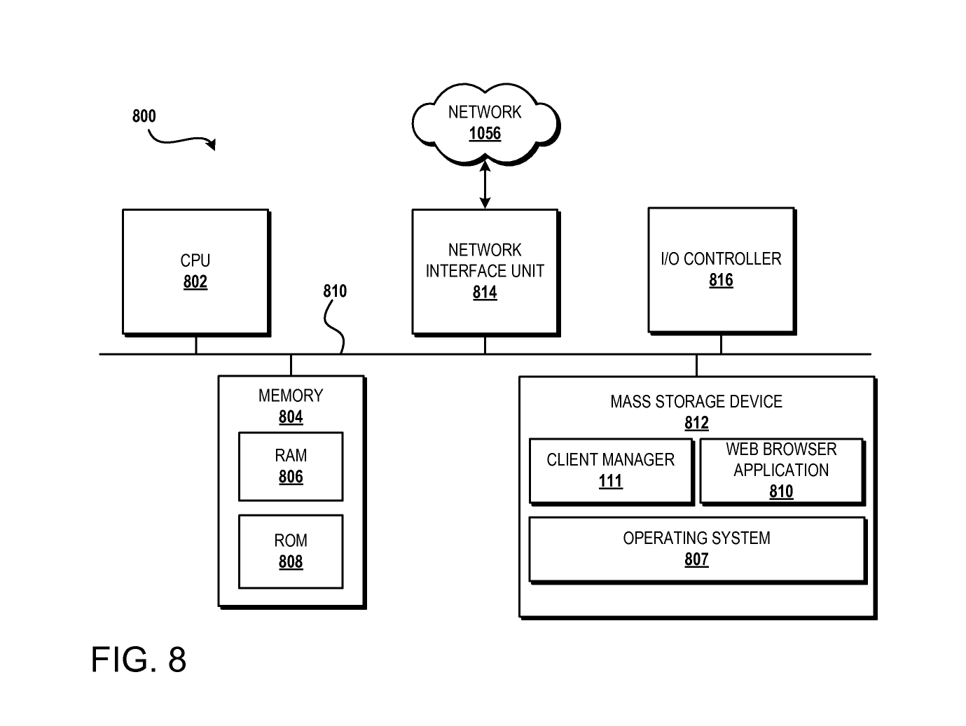

In the following detailed description, references are made to the accompanying drawings that form a part hereof, and in which are shown by way of illustration specific configurations or examples. Referring now to the drawings, in which like numerals represent like elements throughout the several figures, aspects of a computing system, computer-readable storage medium and computer-implemented methodologies for providing contextually aware management of resources. As will be described in more detail below with respect to FIGS. 8-10, there are a number of applications and services that can embody the functionality and techniques described herein.

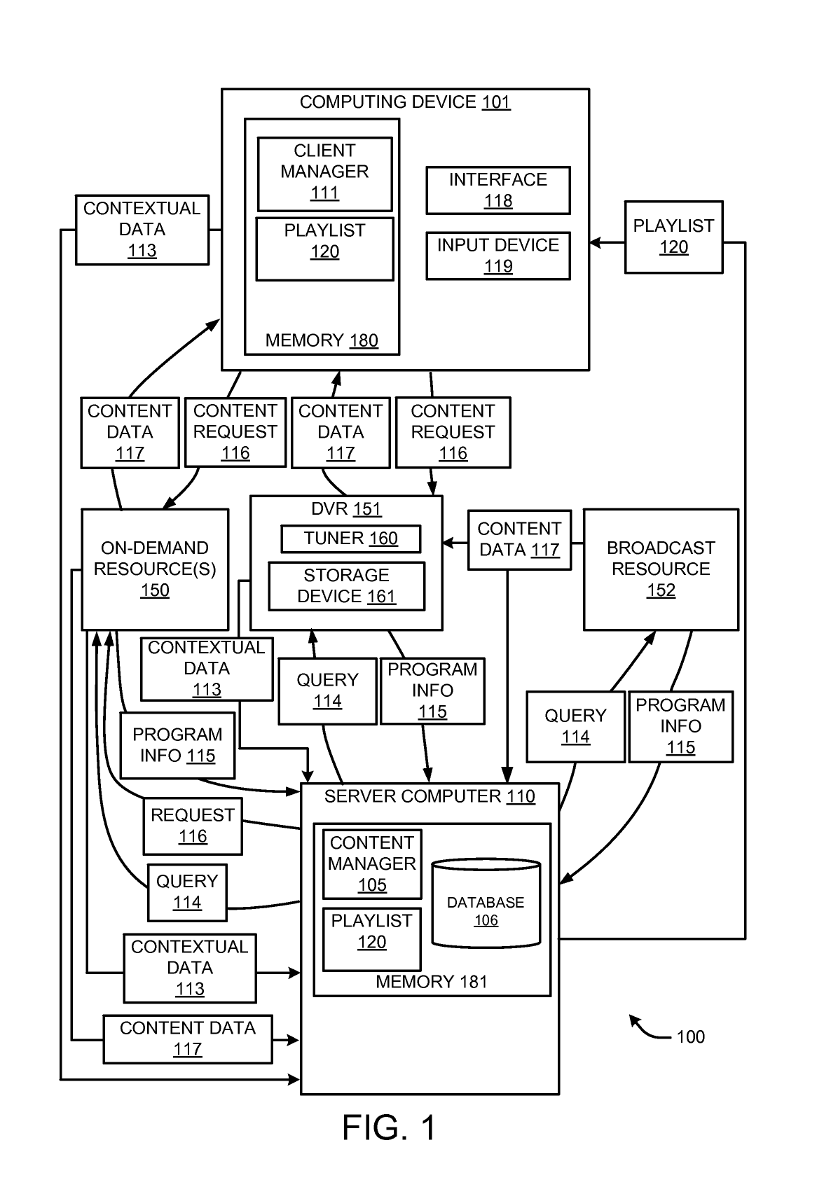

FIG. 1 is a system diagram showing aspects of one illustrative mechanism disclosed herein for providing contextually aware management of resources. As shown in FIG. 1, a system 100 includes a computing device 101, a server computer 110 and a number of content resources 150-152. In this illustrative example, the content resources 150-152 include an on-demand resource 150, a DVR 151 and a broadcast resource 152.

The on-demand resource 150 may include any service, data store, application or device capable of sharing content data 117, such as a streaming video. Illustrative examples of several on-demand resources 150 include NETFLIX, YOUTUBE, HULU and AMAZON INSTANT VIDEO. Any computing device, such as the computing device 101 or the server computer 110, may communicate a content request 116 to any resource, such as the on-demand resource 150. In response to the content request 116, content data 117 is communicated from one or more resources 150-152 to the requesting device. Content data 117 provided by any resource, such as the on-demand resource 150 or the broadcast resource 152 may be received by any computing device for recording of the content data 117. As will be described herein, recordings of content data 117 may be performed by a local device, such as the DVR 151, or a service implemented on a server, such as the server computer 110.

In some configurations, one or more resources, such as the on-demand resource 150, may communicate program information 115, such as a list of content items, e.g., movies or televisions shows. Any computer, such as the server computer 110, may communicate a query 114 to a resource, such as the on-demand resource 150, for program information 115. In response to the query 114, the program information 115 is communicated from one or more resources 150-152 to the device or system sending the query 114.

Although the illustrative example of FIG. 1 shows a single on-demand resource 150, the techniques and technologies presented herein may apply to any number of on-demand resources 150. For example, in the techniques described herein, the server computer 110 may access a number of different on-demand resources 150, such as HULU, NETFLIX AND YOUTUBE, to receive, process and/or analyze program information 115 and content data 117. In another example, the server computer 110 may access individual on-demand applications installed on a gaming console or computer to receive and analyze program information. The techniques and technologies presented herein may apply to any number of services and/or resources that share on-demand content.

The broadcast resource 152 may include any resource, device or system that shares content using a broadcast distribution model. The broadcast resource 152 may deliver content according to a pre-scheduled program. Illustrative examples of several broadcast resources 152 include any network television channel, a cable channel or any other resource of shared content. The broadcast resource 152 may communicate content data 117 to any device, such as the DVR 151 or server computer 110, through any communication medium. Although the examples herein describe the content data 117 as video data, it can be appreciated that the techniques described herein may apply to any type of data including still images, documents or any other data structure.

Program information 115 may originate from any device or resource, such as the broadcast resource 152 or the DVR 151. Any computer, such as the server computer 110, may communicate a query 114 to any device or resource, such as the broadcast resource 152, for program information 115. In response to the query 114, the program information 115 is communicated from the broadcast resource 152 to any device or system sending the query 114.

The DVR 151 may be any type of computing device, such as a personal computer, a server and/or a number of computing devices configured to perform aspects of the techniques described herein. In one illustrative example, the DVR 151 may be a set top box having at least one tuner 160 for receiving content data 117 from the broadcast resource 152. In addition, the DVR 151 contains a storage device 161 for storing the content data 117. The DVR 151 may also communicate program information 115 to any computer, such as the server computer 110, in response to receiving a query 114. In addition, the DVR 151 may communicate content data 117, which may be delivered in the form of streaming data, to any device, such as the computing device 101. The content data 117 may be pushed to any computer or communicated in response to a content request 116.

Although the illustrative example of FIG. 1 shows a DVR 151 with only one tuner 160, configurations disclosed herein may include any number of tuners 160 and the tuners may be located in any device, which may be part of the DVR 151 or any other computer or device. For example, the DVR 151 of FIG. 1 may have two tuners. As will be appreciated by the examples described herein, if there are three programs that are to be recorded, the prioritization and selection of programs to be recorded or linked applies to such configurations or other configurations having any number of tuners 160. For illustrative purposes, a tuner 160 may be any device that is capable of tuning to a broadcast source. Some examples may include ATSC, DVB, PAL, NTSC, CableCARD, QAM, Satellite TV (DirecTV, Dish, etc.), AM/FM Radio, Satellite Radio, etc. As can be appreciated, these examples are provided for illustrative purposes and are not to be construed as limiting.

The computing device 101 may be any type of computing device, such as a mobile phone, a tablet computer, a server, a laptop computer, a combination of computers or a desktop computer. The computing device 101 may include a display interface 118 for displaying data, such as program information 115 and content data 117. The computing device 101 also includes an input device 119 for receiving input from a user. The display interface 118 may be a touch-sensitive display screen that is operable to display images and/or video data, and also operable to receive input from the user, input that may involve a touch signal that indicates an input gesture. The computing device 101 may also include memory 180 storing program information, such as a playlist 120 and a client manager 111.

The server computer 110 may be any type of computing device, such as a personal computer, a server or a number of computing devices configured to perform aspects of the techniques described herein. The server computer 110 may include memory 181 for storing a content manager 105 that is configured to receive, process and manage data described herein, such as contextual data 113, program information 115 and other data. The content manager 105 may also be configured to manage data stored in a database 106, which may include the storage of the contextual data 113.

As described in more detail herein, the contextual data 113 received by the content manager 105 is used to select content items, such as a program title, from received program information 115. The content manager 105 also analyzes the contextual data 113 to determine if the selected content items are to be recorded by the DVR 151. If the contextual data 113 indicates that the selected content items are to be recorded, the content manager 105 causes a computer or device, such as the DVR 151, to record the selected content item. As can be appreciated, a recording may involve the communication of content data 117 from the broadcast resource 152 to the DVR 151 or another device for storage of the content data 117. In some configurations, based on the contextual data 115, the server computer 110 may also record selected content items from any one of the resources 150-152.

The content manager 105 also analyzes the contextual data 113 to determine if the selected content items are to be accessed from the on-demand resource 150. If the contextual data 113 indicates that the selected content items are to be accessed from the on-demand resource 150, the content manager 105 generates or obtains a link configured to provide access to the selected content item from the on-demand resource 150. The link may include any type of data, data structure, or code to enable communication between two or more computers. The link may include any type of data, such as unique identifiers, credentials, certificates and/or a uniform resource locator “URL” suitable for communicating and/or accessing data, such as content data 117 from the on-demand resource 150.

The content manager 105 also generates and maintains one or more playlists 120. For illustrative purposes, the playlist 120 is also referred to herein as the “cross-platform programming playlist 120.” The content manager 105 may configure the playlist 120 to include user-selected content items and/or content items selected by the content manager 105. The playlist 120 may include content items, which may be listed using any identifying information such as a program title or series title. The listed content items may be stored on a device or available on one or more on-demand resources 150. As will be described in more detail below, the playlist 120 may be used to generate one or more user interfaces that include one or more controls and/or links for invoking a content request 116 for playback of content data 117 stored on a device, such as the DVR 151 or the server computer 110.

For content items that are to be accessed from the on-demand resource 150, the playlist 120 may be used to generate one or more user interfaces that include one or more controls and/or links for allowing a user to access content provided by at least one on-demand resource 150. For example, a user of the computing device 101 may select a content item from a user interface containing information from the playlist 120 causing the client manager 111 to communicate a content request 116 to the on-demand resource 150. In response to receiving the content request 116, the on-demand resource 150 communicates content data 117 for viewing on the interface 118. In some configurations, the playlist 120 may be generated by the server computer 110, and communicated from the server computer 110 to the computing device 101 for storage in the memory 180 and/or display on the interface 118. The features of the playlist 120 described herein provide a structure allows the generation of a single interface that enables users to select any content item to initiate a viewing session from any type of resource, which may be an on-demand resource 150, a DVR 151 or any other device.

In some configurations, the computing device 101 and the server computer 110 may operate as stand-alone devices. In such configurations, the computing device 101 and the server computer 110 may each be configured to perform the techniques described herein. In addition, the server computer 110 and the computing device 101 may be interconnected through one or more local and/or wide area networks. In such configurations, the computing device 101, the server computer 110 and/or other computing devices may be configured to operate in concert to perform the techniques described herein.

In some configurations, the content manager 105 receives contextual data 113 from a number of devices, such as the computing device 101, the on-demand resource 150 and the DVR 151. The contextual data 113 may include any information related to a user, a profile, a storage device, tuner and/or any computing device. For example, the contextual data 113 may include information describing user activity, user subscriptions and/or user preferences. In some illustrative examples, the contextual data 113 may include data describing a user selection of a content item or a selection of an interest indicator, e.g., a “follow” or “like” associated with a show. The selection of the interest indicator may be provided as an input to any device, service, platform or social network. In another illustrative example, the contextual data 113 may include information describing the user's activity, such as a user's search history, chat history or any other data related to content stored on, or provided by, any of the content resources 150-152. The user activity may be interpreted by the system 100 to identify one or more selected content items.

In other examples, the contextual data 113 may describe one or more user preferences. In such configurations, the contextual data 113 may indicate that a user prefers to view content on a particular device using a particular delivery method. The contextual data 113 may also indicate that a user prefers to view content available at a particular quality, e.g., 1080p, or content that is commercial free. As described in other examples herein, contextual data 113 may also indicate that a user prefers a particular viewing experience, such as a viewing experience on platform that enables fast-forwarding through commercials and/or other portions of content. Such contextual data 113 may be received by a file, profile or interpreted from user activity.

The contextual data 113 may also describe the capabilities and/or a status of one or more devices or services. For example, as will be described in more detail below, the contextual data 113 may describe the availability of the tuner 160 of the DVR 151. In other examples, the contextual data 113 may describe the status of the storage device 161 of the DVR 151 or a status of an account of one or more on-demand resources 150.

The contextual data 113 may also describe the capabilities and/or a status of one or more accounts or services. For example, as will be described in more detail below, the contextual data 113 may describe a rate, e.g, a price, for content shared by one or more resources 150-152. In addition, the contextual data 113 may indicate a status of one or more accounts associated with a resource. In an illustrative example, the contextual data 113 may indicate if a user subscribes to an on-demand resource 150, whether the user has a fixed fee arrangement or a per-content item fee arrangement and/or a status indicating if a user account is current or delinquent. These examples are provided for illustrative purposes and are not to be construed as limiting, as the contextual data 113 may include any information related to an account or service.

When the contextual data 113 includes user-selected content items, the server computer 110 adds the user-selected content items to the playlist 120. Based on content items on the playlist 120, the server computer 110 continually monitors program information 115 that is updated by the resources 150-152. The server computer 110 parses the program information 115 and identifies additional content items that are related to the content items on the playlist 120. In some configurations, the server computer 110 may continue to send queries 114 to the resources 150-152 for updated program information 115. Also, updates to the program information 115 may be pushed to the server computer 110 from the resources 150-152.

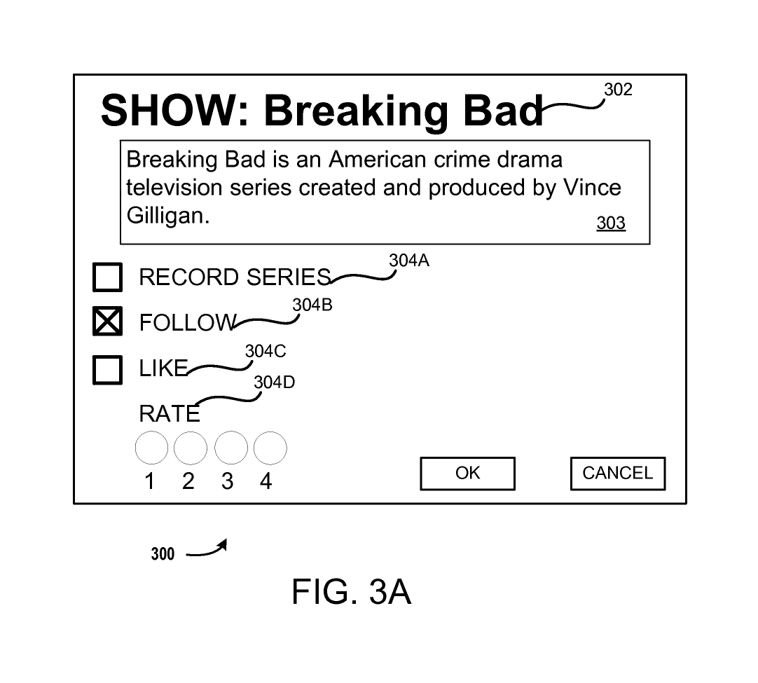

For example, if a user indicates they would like to “follow” or “record” a particular series, e.g., BREAKING BAD, the related title and other descriptive information may be added to the playlist 120. The server computer 110 may then continuously check program information 115 related to the resources 150-152 to identify and select content items, e.g., new episodes or other related content, to be added to the playlist 120. The playlist 120, and updates to the playlist 120, may be communicated to the computing device 101 for display on the interface 118. An example user interface (“UI”) used to display the aggregated program information is described below and shown in FIGS. 3A-6.

Once a content item is identified and selected for the playlist 120, based on the contextual data 113, the server computer 110 may instruct the DVR 151 to record the selected content item. Alternatively, based on the contextual data 113, the server computer 110 may provide a link configured to access to the selected content item shared by one or more on-demand resources 150.

To illustrate one example, it is a given that the server computer 110 receives contextual data 113 indicating the user is interested in a program, e.g., THE SIMPSONS. It is also a given that a user profile indicates that the user as a subscription to the on-demand resource 150 and that they prefer to save resources on the storage 161 of their DVR 151. In addition, it is a given that program information 115 received by the server computer 110 indicates that both the on-demand resource 150 and the broadcast resource 152 provide new episodes of the program. Given the user preferences, which can be defined in contextual data 113 received and processed by the server computer 110, the server computer 110 may generate a link providing access to the program on the on-demand resource 150 instead of instructing the DVR 151 to record the program. In addition, the playlist 120 may be configured with the link, which may be used in an interface for allowing a user to select the link to initiate a viewing session of the program from the on-demand resource 150.

To illustrate another example, it is a given that the server computer 110 receives contextual data 113 indicating the user is interested in two different programs, e.g., THE SIMPSONS and The Family Guy. It is also a given that the received program information 115 indicates that both programs are broadcasted at the same time by the broadcast resource 152. In this example, the on-demand resource 150, AMAZON, also provides access to all episodes of The Family Guy. In addition, the DVR 151 is configured with one tuner 160. Given this scenario, the server computer 110 may generate a link providing access to The Family Guy from the on-demand resource 150. In addition, the server computer 110 may instruct the DVR 151 to record THE SIMPSONS. This result may occur since the tuner 160 is not available to simultaneously record both programs from the broadcast resource 152.

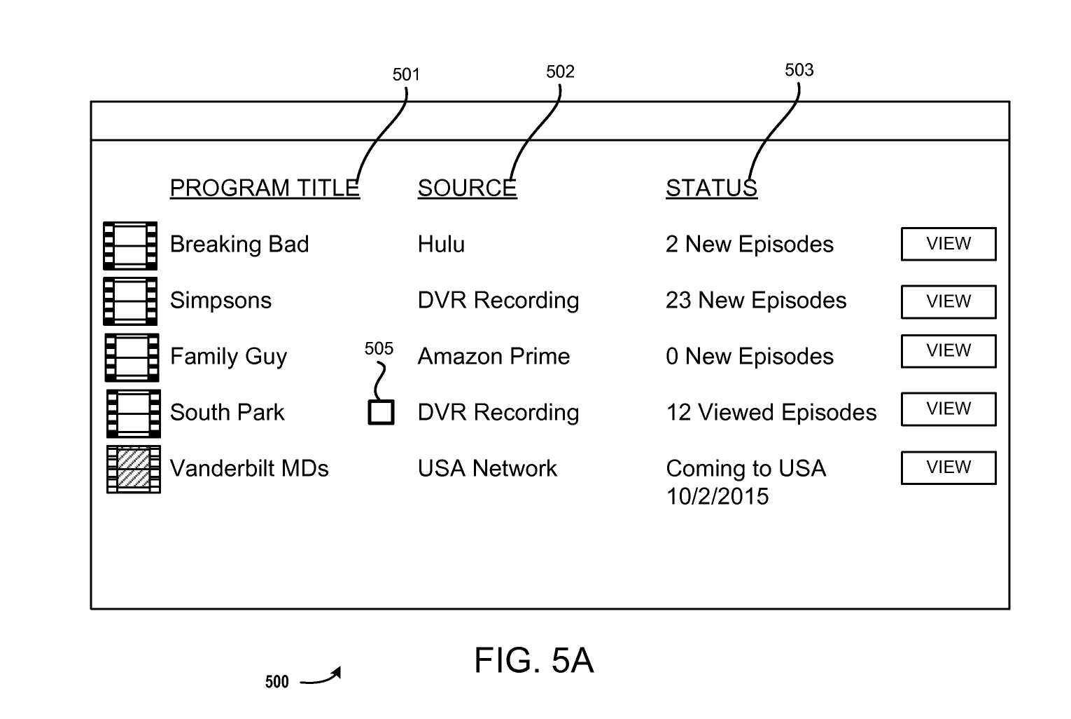

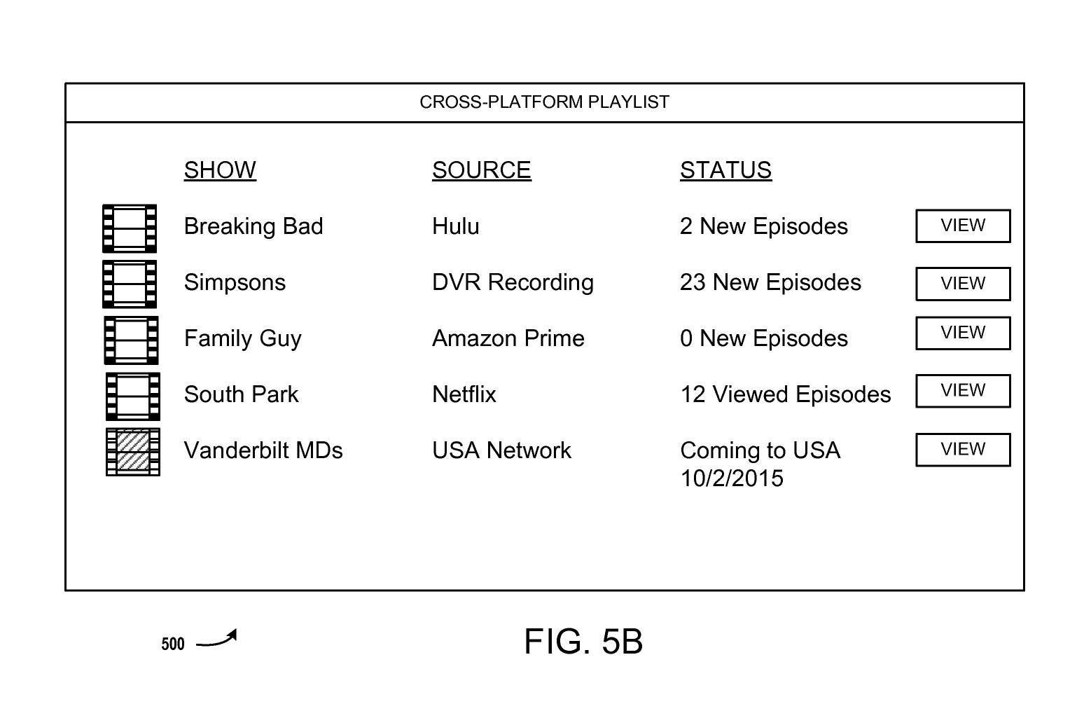

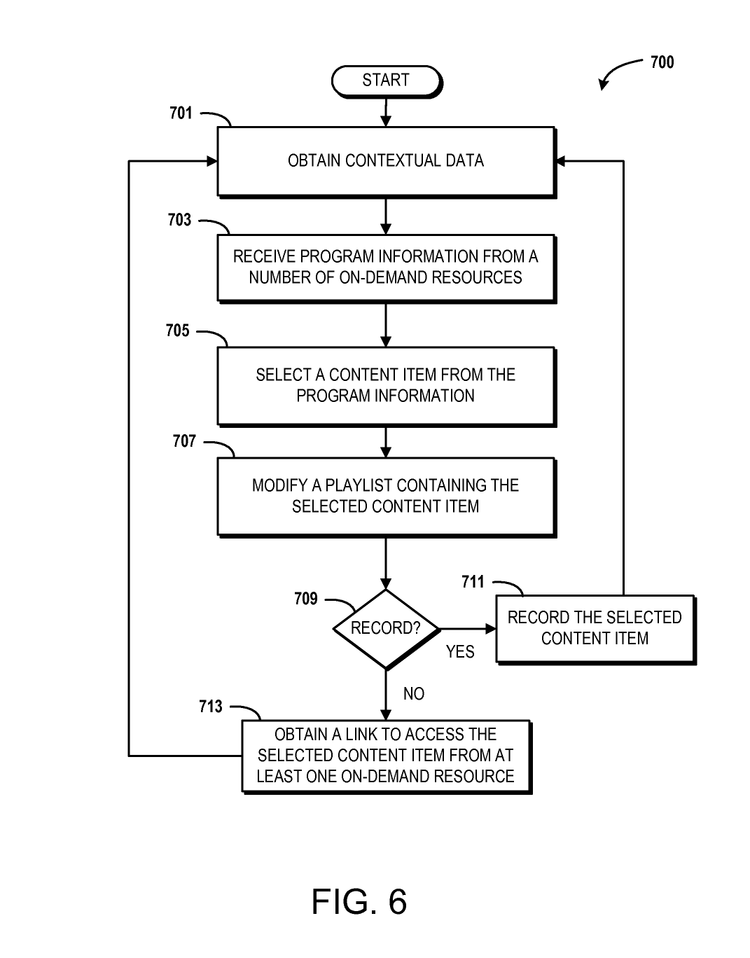

The technologies disclosed herein also provide techniques for allocating storage space on the DVR 151. In some configurations, a recorded content item is deleted from the storage device 161 of the DVR 151 depending on the availability of alternate resources sharing the content item and/or other contextual data 113. For example, if the storage device 161 of the DVR 150 has reached a threshold with respect to its storage capacity, configurations disclosed herein analyze the content item stored on the DVR 151 to determine if the content item is provided by at least one on-demand resource 150, such as NETFLIX. If the content item stored in the storage device 161 of the DVR 151 is available on at least one on-demand resource 150, the system 100 may delete the content item from the storage device 161 of the DVR 151 and generate a link providing access the content item from the on-demand resource 150. The link may then be added to the playlist 120. An example of an interface displaying information related to this example is described below and shown in FIGS. 5-6. As will be described in more detail below, when the link is added to the playlist 120, a user interface displaying the content items of the playlist 120 may not indicate that a recording list has changed except, in some configurations, a listing of the resource of the content may change. By use of these techniques, more storage space may become available without requiring a user to manually select content items to delete.

As will be described below, in addition to preserving resources, such as storage space on a DVR, the use of the contextual data allows the system to process preferences and other information related to system components, which may indicate a desire to trade off storage space for other benefits. As will be described below, based on the user preference and/or a number of factors derived from the contextual data, the system may provide a link to content of an on-demand resource or record content data from a broadcast resource. Such techniques may be based on consumption preferences and/or circumstances related to one or more devices and/or accounts. It can be appreciated that techniques provided herein may replace a link to on-demand content items with a link to recorded data as well. Thus, in addition to deleting content, techniques described herein may add content to a storage device, such as the DVR.

Other factors derived from the contextual data 113 may influence the determination of whether the content item is deleted from the storage device 161. For instance, a user profile may indicate that a user may not want to delete the content item if there is a charge associated with a viewing of the content item on the on-demand resource 150. In addition, the user profile may define one or more price thresholds for content. For example, a profile may indicate that a content item may be deleted from the storage device 161 of the DVR 151 only if the content item is available on an on-demand resource 150 for less than $1.00, or if the content item has been purchased via one or more resources. These examples are provided for illustrative purposes and are not to be construed as limiting.

The server computer 110 may utilize a number of factors to determine if alternative content is available. For example, the system 100 may determine that alternative content is available if a particular content item meets one or more thresholds and/or conditions related to video quality, video format, available delivery methods and/or other features. For instance, based on one or more consumption preferences and/or other factors, the system 100 may determine that an alternative source for a content item is not suitable if the delivery of the content involves commercials or does not have the ability to fast-forward through commercials. In another example, the system 100 may determine that an alternative resource for a content item is not suitable if the on-demand resource providing the content does not provide the content with a video quality, e.g., a particular format and/or resolution, that meets a threshold defined in a user profile.

In other examples, by use of the configurations disclosed herein, the server computer 110 may select resources 150-152 for different reasons. For instance, configurations disclosed herein enable the system 100 to select resources 150-152 based on a viewing experience. When utilizing such factors, recording content from the broadcast resource 152 using the tuner 160 may provide a better experience with respect to streaming lag and other features such as pause and rewind functions. In addition, recording content from the broadcast resource 152 may provide a better experience with respect to functions that allow users to skip commercials.

In other illustrative examples, configurations disclosed herein enable the system 100 to select resources 150-152 based on subscriptions, fee structures and/or other factors related to an account or account status. When utilizing such factors, which may be combined with other factors derived from the contextual data 113, the system 100 may select the use of an on-demand resource 150 because an associated user subscribes to a service of the on-demand resource 150. In addition, the system may select a particular provider because a price of one on-demand resource 150 is better than another on-demand resource 150.

In addition, by the use of contextual data 113 that includes consumption preferences, users may indicate services and/or resources 150-152 to avoid, such as ones that they do not subscribe to or services that require extra payments. In yet another example, a particular resource may be selected because it provides a more integrated experience that allows deep links directly to the DVR content from the interface. These examples are provided for illustrative purposes and are not to be construed as limiting, as any combination of factors may influence the selection of the resources 150-152. In addition, the techniques herein may configure resource management choices and allow the system 100 to free up tuners, such as tuner 160, when there is a conflict in activity that involves recording and/or playing content from one or more resources 150-152.

As described in the examples provided herein, the utilization of the contextual data 113 provides a number of benefits. For instance, techniques described herein may be used to manage resources, such as storage space on the DVR 151. The use of the contextual data 113 allows the system 100 to process preferences and other information regarding devices and components, which may indicate a desire to trade off storage space for other benefits. The use of the contextual data 113 may also provide some benefit in optimizing the use of other devices and components, such as the tuner 160. In addition, the use of the contextual data 113 including one or more preferences may allow the system 100 to enhance a user's viewing experience, e.g., an automatic selection of a resource that mitigates the appearance of commercials. In such scenarios, based on the user preference and/or a number of factors derived from the contextual data 113, the system 100 may provide a link to the on-demand resource 150 or record content data 117 from the broadcast resource 152 based on consumption preferences and/or circumstances related to one or more devices and/or accounts. It can be appreciated that techniques provided herein may replace a link to on-demand content items with a link to recorded data as well. For example, based on preferences indicating a desire to have a better viewing experience, and based on storage space and tuner availability, once a program becomes available on a broadcast resource, the system 100 may record the content item from a broadcast source and then replace a link of on-demand content. Thus, techniques described herein may add content to a storage device, such as the DVR 151.

The configurations disclosed herein provide a granular level of management of devices. Multiple factors derived from contextual information related to different resources may be combined for processing. For instance, if a device has a large storage capacity, and preferences indicate a desire to use most of the storage capacity, the system will record as much content as possible. In such a scenario, when additional space becomes available, or a show ends up on a broadcast resource that was previously only available on-demand, the system may schedule a recording and as soon as that show is available. The system may then automatically replace the on-demand link with the recording link for the best possible experience. In another example, if the system has a smaller storage device, then preferences may indicate conservation of storage space which would favor a process of replacing the recording link with an on-demand link in a manner as described herein.

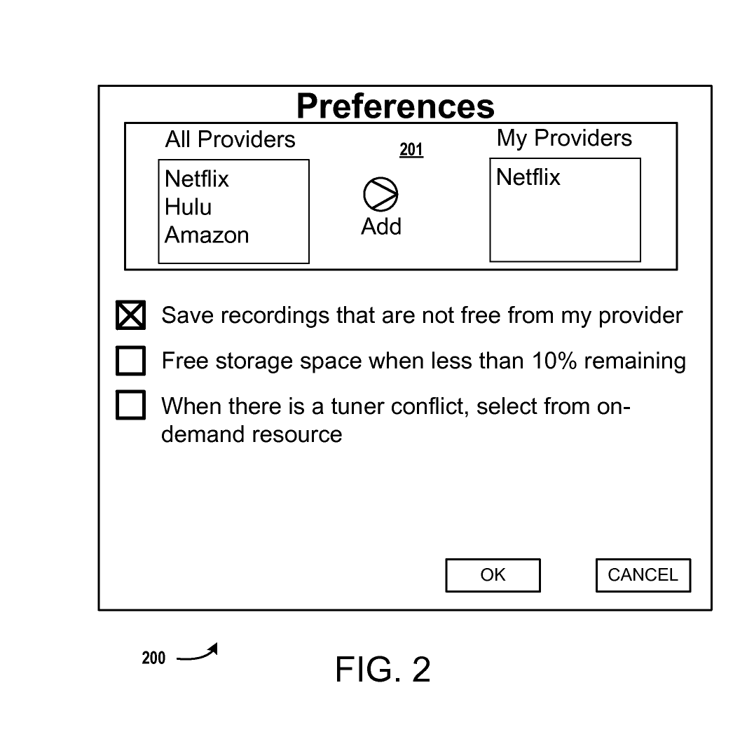

Turning now to FIGS. 2-6, different examples of graphical user interfaces are illustrated as screen diagrams that display information relating to techniques for providing contextually aware management of resources. In addition, the examples disclosed herein provide techniques for allocating storage space on a device based on the contextual data 113. The screen diagrams presented are for illustrative purposes only, and are not intended to be limiting. For example, other visual interfaces, including those in a three-dimensional “3D” environment, as well as non-visual interfaces, e.g., voice and touch, might be utilized to perform the functionality described herein.

FIG. 2 is a screen diagram showing an illustrative graphical UI 200 that displays data relating to preferences used by techniques described herein. In some configurations, the UI 200 may be generated by the client manager 111, shown in FIG. 1, and presented on a computing device, such as the computing device 101. As will be described in detail below, a user input obtained by the UI 200 may cause the generation of contextual data 113 that may be used, for example, to manage the storage of data, the generation of and/or modifications to the playlist 120. In addition, the user input obtained by the UI 200 may cause the generation of contextual data 113 that may be used, for example, to manage devices and/or computers, such as the devices and computers shown in FIG. 1.

The UI 200 is an example of a preferences interface that includes a provider selection UI element 201 and a number of selectable preference UI elements. Using the provider selection UI element 201, the user may select individual providers, such as NETFLIX, HULU and other on-demand resources. The provider selection UI element 201 may also allow a user to select a priority with respect to selected providers. As described in examples provided herein, when the user selects one or more providers, resources associated with the selected providers may be prioritized over other resources.

In the illustrative example of FIG. 2, the selection of a “Save recordings that are not free from my provider” option causes the system 100 to record content in one or more scenarios. For example, if a particular show is provided by two resources: a broadcast resource, such as NBC, and an on-demand resource, such as AMAZON, and AMAZON only streams the particular show for a fee, the selection of this option may cause the system 100 to record the content from the broadcast resource instead of providing a link to AMAZON. In addition, such a preference may prevent the system 100 from deleting stored content items given that the alternative on-demand resource is associated with a fee.

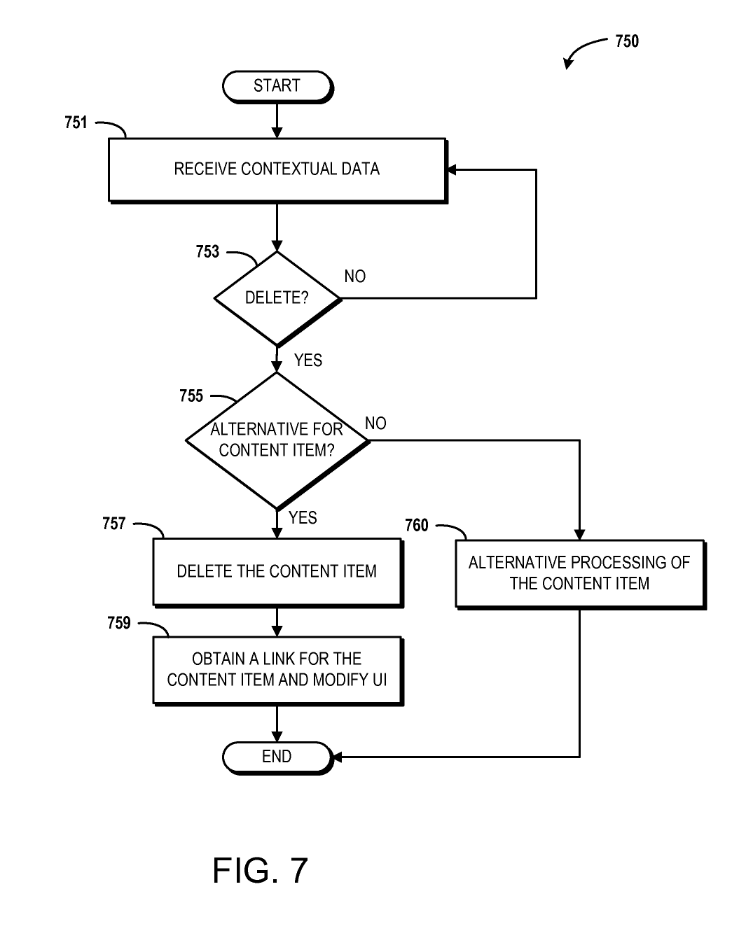

Also shown in the example of FIG. 2, the selection of a “Free storage space when less than 10% remaining” option causes the system 100 to manage one or more devices, such as the storage device 161, and allocate storage space for additional content. For example, the selection of this option may cause the system 100 to monitor one or more storage devices. When at least one storage device reaches a threshold, the system 100 may delete a content item if a suitable alternative of the content item is available on at least one on-demand resource 150. If a suitable alternative of the content item is available, e.g., alternative content meets a quality threshold and/or other conditions, the system 100 may delete the stored content item and provide a link to the alternative resources. Additional details of techniques using such a preference, which may be combined with other contextual data 113, is shown in FIG. 7.

By the use of contextual data that defines one or more thresholds and/or other settings, in addition to deleting content, the system may be configured add content. With reference to the above-described example, a threshold may be established by an interface or other form of input, and the system may be configured to record additional content if there is more than a threshold amount, e.g., 10%, of storage space available. For instance, if a content item from an on-demand resource is listed on a playlist, and the contextual data indicates that the utilized storage space is less than a threshold amount, in addition to other possible factors derived from the contextual data, the system may record the content item from a broadcast resource and replace the link to the on-demand resource with a link to the recorded video data associated with the content item.

In addition, in the example of FIG. 2, the selection of a “When there is a tuner conflict, select from on-demand resource” option causes the system 100 to monitor one or more devices, such as the tuner 160, and take different actions in certain scenarios. In one example, the selection of this option may cause the system 100 to monitor program information 115 and/or other contextual data 113 and manage the recording of certain content items. If it is determined that two shows are provided via a television broadcast at the same time, and there is only one available tuner 160, the system 100 may determine that one of the shows is to be provided by an on-demand resource 150, such as NETFLIX.

The preferences interface illustrated in the UI 200 is intended for illustration purposes, and are not intended to be limiting. The contextual data 113 that is generated by interactions with the UI 200 is just one example of how consumption preferences and other preferences may be obtained by the system 100. As also described herein, such data may be obtained implicitly. For example, contextual data 113 including preferences and other information may also be obtained by processing data describing user activity, such as viewing habits, or data describing the status of a device and/or hardware capabilities. Any type of contextual data 113 defining preferences that is obtained from any resource and/or device may be used with techniques described herein.

As summarized above, the contextual data 113 may include the selection of one or more content items. The selection of a content item may be explicit or implicit. For example, a content item may be selected by a user interacting with a user interface displaying a program guide or an interface of a social network, search engine and/or any other platform or service. FIGS. 3A and 3B illustrate examples of two graphical UIs that may be used to select one or more content items.

FIG. 3A is a screen diagram showing an illustrative graphical UI 300 that displays information relating to the selection of a content item 302. In this illustrative example, the content item 302 is described with the title “BREAKING BAD.” The UI 300 also displays text describing the content item 302 in a text field 303. In addition, the UI 300 includes a number of selectable menu items 304A-304D. The UI 300 may be generated by the client manager 111, shown in FIG. 1, and presented on a computing device, such as the computing device 101.

In the example shown in FIG. 3A, the user may provide the selection of the content item 302 by selecting one or more of the menu items 304A-304D. For instance, the user may express interest in the content item 302 by selecting the “follow” UI element 304B or the “like” UI element 304C. The use of the “follow” UI element 304B and the “like” UI element 304C should not be construed as limiting, as the user's interest may be expressed in a number of ways. For instance, interest in the content item 302 can be expressed by the selection of the “record series” UI element 304A or the “rate” UI element 304D.

The selection of a content item 302 may be expressed by any other action and/or input such as a user's search patterns, activity on a social network or any type of voice or text communication. User activity may be receive by the content manager 105 in the form of contextual data 113. Based on the contextual data 113, the content manager 105 may process any data, such as the program information 115, the content data 117 and/or other data in the manner described herein. For example, in the illustration shown in FIG. 3A, the selected content item 302 may be added to a playlist 120 generated by the content manager 105.

FIG. 3B is a screen diagram showing another illustrative graphical UI 350 that displays information relating to the selection of a content item 302. As illustrated in FIG. 3B, the UI 350 includes a search element 351 configured to receive an input. In this example, the user has entered the text “BREAKING BAD,” and upon receipt of this input, the system 100 searches one or more resources and/or the program information 115 received from the resources 150-152. Any known search technique may be utilized to identify related content items using the input received by the search element 351.

In the example shown in FIG. 3B, the UI 350 illustrates a number of search results listing the title and source of the discovered content items. In this illustrative example, the first season of the show BREAKING BAD is available on two different resources: an on-demand resource 150 (NETFLIX) and a DVR (a recording from a broadcast resource 152). In addition, in this example, the UI 350 indicates that the second season of the show, BREAKING BAD, is not available. In such a scenario, e.g., when content is not available, the UI 350 provides additional information describing when the second season will be available.

As shown in the example of FIG. 3B, the search results may display content items from multiple sources, including on-demand resources 150 and/or a broadcast resource 152. Some of the content items these may be available immediately from a preferred provider. When the user selects a particular “+” UI element corresponding to a particular content item, that particular content item is added to the playlist 120. If the content is not yet available, such as season two of BREAKING BAD, and the user adds season two to the list, the playlist 120 may be populated with the title and information describing when the second season will be available. When the content becomes available, the playlist 120 may be configured with a link and/or control to invoke a viewing session of the newly available content.

The playlists 120 and/or the UI's displaying the data of a playlist 120 may include a number of other features. For instance, the content items of one or more playlists 120 may be sorted based on one or more factors. In one illustrative example, the content items may be sorted based on the contextual data 113, which may define or describe user preferences, user activity and/or other information related to a device or computer. In addition, the playlist 120 may include suggested content items or structures of obtaining suggested content items. In such configurations, when a user selects a content item on a displayed playlist 120, the server computer 110 may provide a suggested content item or a list of suggested content items. The display of suggested content items may be based on the contextual data 113. In addition, content items and/or suggested content items may be selected for display and/or prioritized based on the contextual data 113. Such configurations would allow a playlist 120 to include entries and sub-entries of content items based on various available sources and/or optimal resources in sorted manner.

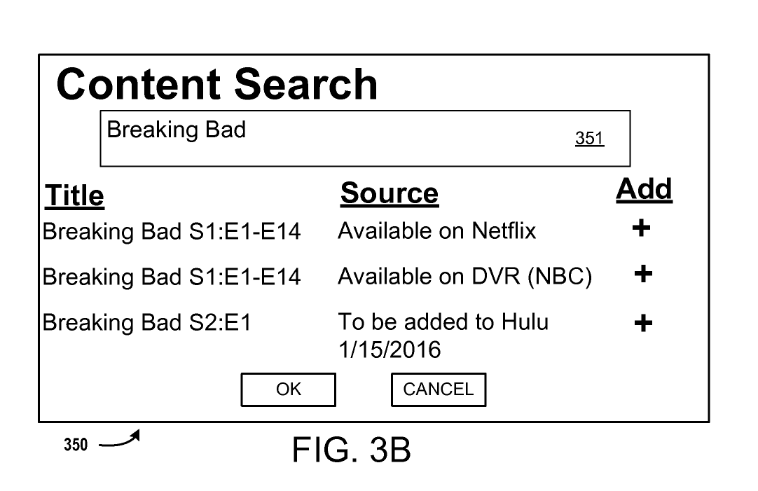

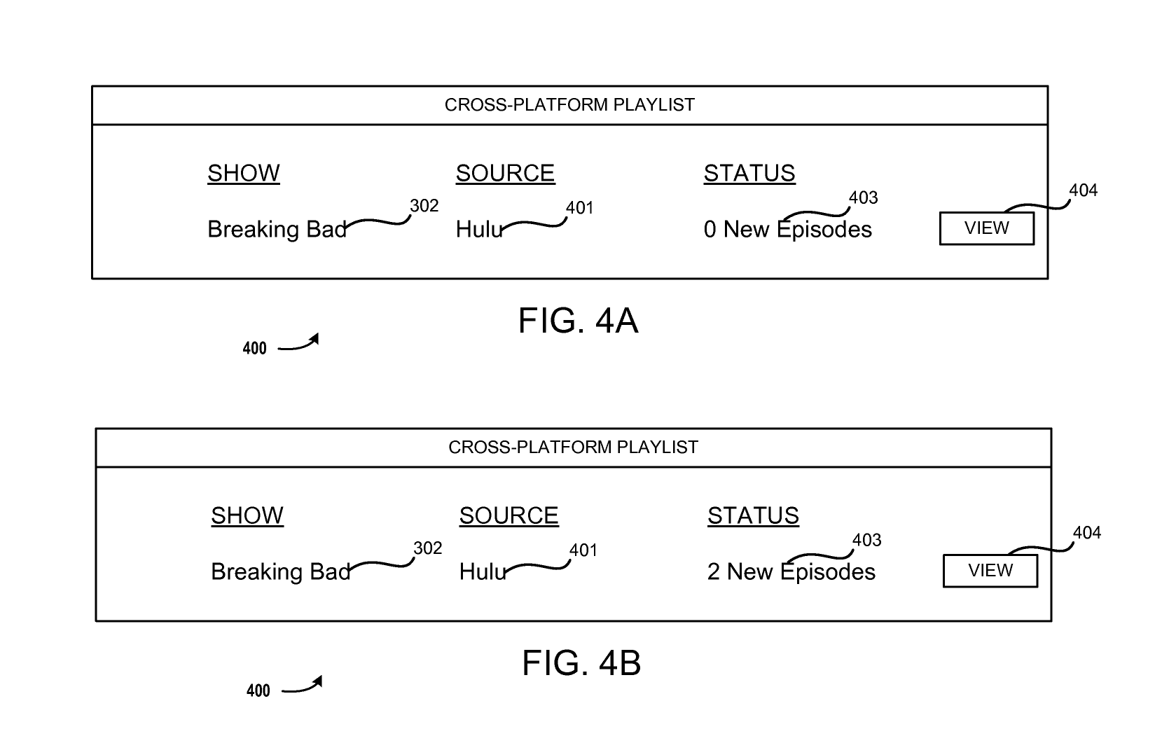

FIG. 4A is a screen diagram showing an illustrative graphical UI 400 that displays information relating to a playlist 120. As illustrated in FIG. 4A, the UI 400 includes the content item 302, a “source” UI element 401, a “status” UI element 403 and a “view” control UI element 404. The UI 400 may be generated by the client manager 111, shown in FIG. 1, and presented on a computing device, such as the computing device 101. The information displayed on the UI 400 is based on data describing the playlist 120, which may be communicated from a remote computer, such as the server computer 110.

In the example of FIG. 4A, the title of the content item 302 is listed as “BREAKING BAD,” and the “source” UI element 401 indicates that the content item 302 is from the on-demand resource 150, e.g., Hulu, and the “status” UI element 403 indicates that there are no new episodes available. The “view” UI element 404 may be configured with a link or control to provide access to the content item 302 shared by the on-demand resource 150. Upon a selection of the “view” UI element 404, the client manager 111 may send a content request 116 to the on-demand resource 150, and content data 117 may be communicated to the computing device 101 in the form of a viewing session of the content item 302, which may be displayed on the interface 118.

In the example of FIG. 4A, it is given that the client manager 111 selected Hulu as the on-demand resource 150. However, in another example, if the client manager 111 determined that the content item 302 is to be received from the broadcast resource 152 and recorded by the DVR 151, the “source” UI element 401 may be labeled with text, such as “DVR,” indicating that the content item 302 can be accessed from a recording. In this example, the “view” UI element 404 may be configured with a link or control that provides access to the content item 302 stored on the DVR 151.

In some configurations, it is possible for the system 100 to list more than one source on the UI 400. For instance, if the system 100 found that “BREAKING BAD” was available on multiple on-demand resources and also stored on a DVR, the multiple resources may be listed, and a “view” control may exist for each individual resource. In one example, the UI 400 may list a “view” control for “Hulu” and another view” control for the content stored on the DVR. In another example, other UI elements may list the various sources. For instance, upon the selection of a control to view the content item 302, such as the “view” UI element 404, the system 100 may present additional options for selecting one of the multiple sources for viewing the content item 302.

As summarized above, when one or more content items are added to the playlist 120 and displayed on the UI 400, configurations disclosed herein continue to receive updated programming information 115. The updated programming information 115 is monitored to identify and select additional content items based on contextual data 113 and/or the content items on the playlist 120. As additional content items are identified and selected, and the additional content items are added to the playlist 120.

FIG. 4B is a screen diagram showing another example of the illustrative graphical UI 400 with updated information. The example of FIG. 4B may be one illustrative user interface that may be displayed after the system 100 identifies and selects additional content items. To further the above-described example involving the show, BREAKING BAD, it is a given in this example that the system 100 has identified and selected two new episodes. Based on the selection of the additional content items, the playlist 120 is then updated to reflect the new information. As shown in the example of FIG. 4B, the “status” UI element 403 now shows that “2 New Episodes” are now available for the user. The user may then select the “view” UI element 404 to invoke a viewing session of the additional content items. Such features reduce the need for users to continually search for new content on multiple platforms.

In addition to generating and updating the playlist 120 with additional content items, the technologies disclosed herein also provide techniques for allocating storage space on one or more devices. In some configurations, a recorded content item is deleted from the storage device 161 of the DVR 151 depending on the contextual data 113 and/or the availability of alternate resources sharing the content item. For example, if the storage device 161 of the DVR 150 has reached a threshold with respect to its storage capacity, configurations disclosed herein analyze the content item stored on the DVR 151 to determine if the content item is provided by at least one on-demand resource 150, such as NETFLIX. If the content item stored in the storage device 161 of the DVR 151 is available on at least one on-demand resource 150, the system 100 may delete the content item from the storage device 161 of the DVR 151. The system 100 may generate a link providing access the content item from the on-demand resource 150. The link may then be added to the playlist 120. An example of an interface displaying information related to this example is described below and shown in FIGS. 5-6.

FIG. 5A is a screen diagram showing an illustrative graphical UI 500 that displays information relating to an example playlist 120. A shown, the UI 500 includes a number of titles under the “PROGRAM TITLE” UI element 501. Corresponding source information and status information are also displayed under the “SOURCE” UI element 502 and the “STATUS” UI element 503. In this example, a number of content items are stored on the storage device 161 of the DVR 151, including: 23 new episodes of THE SIMPSONS and 12 viewed episodes of SOUTH PARK.

To illustrate the example of FIG. 5A, it is a given that storage device 161 of the DVR 151 has reached a threshold with respect to its maximum storage capacity. In addition, it is a given that the on-demand resource 150, e.g., NETFLIX, shares all episodes of SOUTH PARK. Given that there is at least one alternative resource offering the episodes of SOUTH PARK, the system 100 may delete the episodes of SOUTH PARK from the storage device 161 of the DVR 151. In addition, the system 100 may reconfigure the “VIEW” button associated with the episodes of SOUTH PARK to provide access to the content offered by the on-demand resource 150 instead of the DVR 151.

In some configurations, one or more UI elements or a visual indicator may be displayed to indicate that a content item is selected for deletion. In such configurations, an interface displaying the playlist 120 may provide a control that allows a user to provide a confirmation that allows the deletion of the selected content item to proceed. An example of such a control is shown in FIG. 5A as a UI checkbox element 505.

As described herein, the need to allocate storage space may be based on any event, scenario or condition. For example, a need to allocate storage space may be based on a change of an account, a price change of one or more content items, a status change of a device, e.g., a conflict or failure of a device, a schedule change of a program, or any other scenario. A status of a device may also include a status of a component, e.g., that a storage device is near a threshold. In addition, as described in more detail herein, the identification of a suitable alternative for a stored content item may be based on a number of factors, such as user preferences, available delivery mechanisms, video quality and/or other factors.

FIG. 5B is a screen diagram showing another example of the illustrative graphical UI 500 after the system 100 has reconfigured the link to the SOUTH PARK episodes. As shown in FIG. 5B, the UI 500 now indicates that the SOUTH PARK episodes are now available from “NETFLIX” instead of a “DVR Recording.” Although the functionality of the “VIEW” button has been modified to allow access to the content via NETFLIX, the graphics associated with the display of the “VIEW” button remain the same with respect to the UI 500 shown in FIG. 5A.

Techniques provided herein allow for the generation of a single such as UI 500, that provides access to both DVR-recorded content as well as on-demand content. In addition, techniques provided herein also allow the system 100 to change the resource of any content item depending on the contextual data 113 and/or availability of alternative content. It can be appreciated that the examples provided herein are for illustrative purposes and are not to be construed as limiting. The use of the contextual data 113 and the system's 100 access to on-demand content as well as recorded content, among many other benefits, allow users to expand their selection of viewable content beyond the content accessible by a DVR 151. In addition, access to content stored in various resources may be optimized depending on the contextual data 113.

In addition, as summarized above, the contextual data 113 and updated program information 115 may be used to provide information on suggested content, recommendation, information on upcoming content, and/or other announcements. For instance, if the processing of the contextual data 113 and any updated program information 115 does not yield any additional content items, e.g., a new episode of a “followed” show, the system 100 may retrieve the program information 115 enabling the system 100 to display information regarding upcoming episodes or information describing related programs. FIG. 5B illustrates one such example where “VANDERBILT MDS” is indicated as a program of interest. In this example, if a particular content item is not available but may be of interest, information describing upcoming content may be retrieved and displayed to the user. In addition, a visual indicator, such as a shaded icon, may be displayed to represent the status of the content item.

Turning now to FIG. 6, aspects of a routine 700 for providing contextually aware aggregation of cross-platform media programming are shown and described below. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts or modules. These operations, structural devices, acts, and modules may be implemented in software, in firmware, in special purpose digital logic, and any combination thereof.

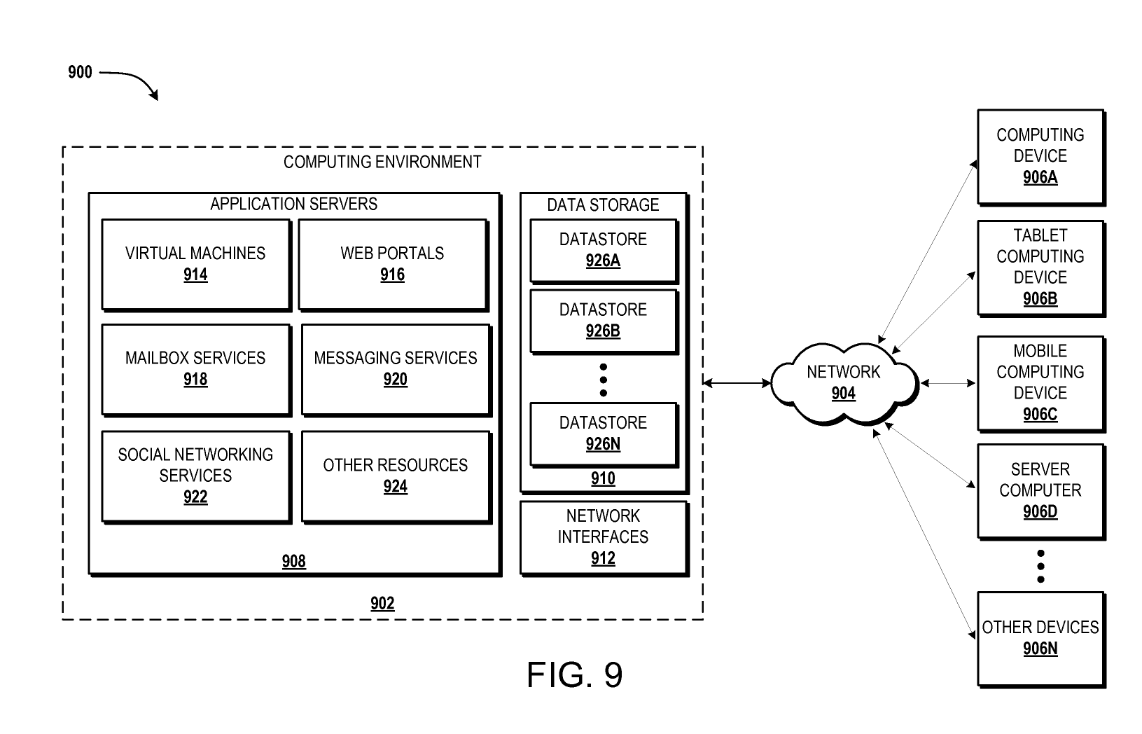

As will be described in more detail below, in conjunction with FIGS. 8-10, the operations of the routine 700 are described herein as being implemented, at least in part, by an application, such as the content manager 105. Although the following illustration refers to the content manager 105, it can be appreciated that the operations of the routine 700 may be also implemented in many other ways. For example, the routine 700 may be implemented, at least in part, by the client manager 111. In addition, one or more of the operations of the routine 700 may alternatively or additionally be implemented, at least in part, by the content manager 105 and/or the client manager 111 working in conjunction with other software modules, such as the one or more application servers 908 of FIG. 9.

With reference to FIG. 6, the routine 700 begins at operation 701, where the content manager 105 obtains contextual data 113. The contextual data 113 is aggregated from a number of devices and/or resources. The contextual data 113 may include data describing user activity, user subscriptions, user preferences, consumption preferences and/or other information. Among other types of information, the contextual data 113 may also describe the capabilities and/or a status of one or more devices.

In some configurations, the contextual data 113 may include a selection of one or more content items. The selection of a content item may be explicit. For example, a user may convey an interest in a television show by selecting an interest indicator, such as a “follow,” “like” or other indicator provided on any platform. In addition, the selection of a content item may be implicit. For example, the contextual data 113 may be generated from a number of actions performed by a user, and a number of actions related to a particular content item. One or more actions may be interpreted to generate contextual data 113 indicating a selection of the particular content item. For example, if a user typically watches video content on an iPad via an on-demand resource, such as NETFLIX, contextual data 113 indicating such consumption preferences may be generated.

In addition, contextual data 113 indicating one or more user preferences and/or consumption preferences may be established by a user or a computing device. For instance, a user may indicate a preference to view content via NETFLIX over HULU or over another resource. The contextual data 113 may also indicate a number of other preferences, which may define parameters related to video quality, price, the availability of applications or content on certain platforms and/or other factors. These examples are provided for illustrative purposes only and are not to be construed as limiting. As described herein, the contextual data 113 may include any type of information from any resource.

Next, at operation 703, the content manager 105 receives program information 115 from a number of resources. In some configurations, the content manager 105 receives program information 115 from a number of resources, including the DVR 151, the broadcast resource 152 and one or more on-demand resources 150 such as, NETFLIX, YOUTUBE and HULU. As can be appreciated, the program information 115 may be received from any computing device storing program information associated with the resources 150-152. In addition, the program information may be pushed to the content manager 105, or the content manager 105 may send queries 114 to one or more resources 150-152 or other devices to receive program information 115 or updates thereof.

Next, at operation 705, the content manager 105 selects additional content items from the program information 115. In some configurations, the additional content items are selected based on a relationship between the content items listed in the updated program information 115 and content items that are already on the playlist 120. In addition, in some configurations, the content manager 105 may also utilize the contextual data 113 to select the additional content items.

In one illustrative example, if the contextual data 113 includes a user selection of a TV show, such as THE SIMPSONS, THE SIMPSONS may be added to the playlist 120 as a content item. In the present example, since THE SIMPSONS are on the playlist 120, the content manager 105 may identify and select content items that are related to THE SIMPSONS. For instance, a related content item may include a new episode of THE SIMPSONS that has become available on NETFLIX or one or more broadcast resources. In this example, the content manager 105 selects the new episode and, as described below with respect to operation 707, the new episode is added to the playlist 120.

In another example, based on the contextual data 113 and the updated program information 115, the content manager 105 may identify and select other content items of interest, such as a suggested content item of a related genre. In the current example where “THE SIMPSONS” is listed on the playlist 120, other animated comedy shows may be selected as additional content items. In yet another example, based on the contextual data 113 and the updated program information 115, the content manager 105 may provide notice of upcoming episodes, content and/or other resources sharing related content items. The system 100 may display information related to any suggested content in any format, which, for example, may include related content items available in movie theaters, stores, web sites, etc.

In some configurations, the selection of the additional content items may be based, at least in part, on contextual data 113 that includes preferences. For instance, one or more preferences established by a user or a device, may be used to identify and select content items having a particular viewing quality, or content that does not include commercials. In other examples, the contextual data 113 may describe pricing preferences, video quality preferences, vendor preferences and other data identifying certain types of content and/or resources.

Next, at operation 707, the content manager 105 may modify the playlist 120 based on the content items selected in operation 705. The playlist 120 provides a mechanism for users to view content provided by multiple platforms without having to access multiple user interfaces and/or multiple systems. In some configurations, the playlist 120 includes text and/or graphics describing the listed content items. In addition, the playlist 120 is configured with controls, such as a “view” button, to launch a viewing session for each of the listed content items regardless of the resource storing the related video data.

Next, at operation 709, the content manager 105 determines if the content items selected in operation 705 should be recorded. In some configurations, the content manager 105 analyzes the contextual data 113 to determine if the selected content items are to be recorded by a device or computer, such as the DVR 151 or the server computer 110.

If the contextual data 113 indicates that the selected content items are to be recorded, routine 700 proceeds to operation 711 where the content manager 105 causes a device, such as the DVR 151, to record the selected content items. In some configurations, a recording may involve the communication of content data 117 from the broadcast resource 152 or the on-demand resource 150 to the DVR 151 for storage of the content data 117 in the storage device 161. If a central storage service is preferred by the user, the recording may involve the communication of content data 117 from the broadcast resource 152 or the on-demand resource 150 to the server computer 110 for storage of the content data 117. A link or control may be added to the playlist 120 allowing a user to launch a viewing session of the recorded content.

At operation 709, if the contextual data 113 indicates that the selected content items should not be recorded, the routine 700 proceeds to operation 713 where the content manager 105 obtains a link and/or a control providing access to the selected content items from at least one on-demand resource 150. In some configurations, data used to create the link or the control, may be provided by an on-demand resource 150. The link may include any type of data, such as unique identifiers, credentials, certificates and/or a uniform resource locator “URL.” The link and/or the control may be integrated into the playlist 120 to allow a user to launch a viewing session for the content shared by one or more on-demand resources 150.

From either operation 711 or operation 713, the routine 700 returns to operation 701 where the content manager 105 receives updated contextual data 113. The routine 700 then loops through operations 701 through 713 allowing the system 100 to continually monitor contextual data 113 and updated program information 115 for additional content items. When the content manager 105 identifies and selects additional content items, the content manager 105 updates the playlist 120 and either records the additional content items or links the additional content items depending on the contextual data 113. By the use of these disclosed techniques, the playlist 120 may be updated as new content of interest becomes available at any one of the resources 150-152. The updates to the playlist 120 are provided without requiring the user to manually check each resource and/or set recordings for newly issued content.

The technologies disclosed herein also provide techniques for allocating storage space on a computing device, such as the DVR 151. In some configurations, recorded content items are deleted from storage depending on the availability of alternate resources sharing the content items and/or other contextual data. For example, if a storage device of a DVR has reached a threshold with respect to its storage capacity, configurations disclosed herein analyze the content items stored in the DVR to determine if the content items are provided by an on-demand resource, Such as NETFLIX. If one or more stored content items are available on at least one on-demand resource, the system may delete the one or more content items from the DVR and generate a link to access the one or more content items from the on-demand resource. The link and a description of the one or more content items may then be added to the cross-platform programming playlist.

Turning now to FIG. 7, aspects of a routine 750 for managing a storage device are shown and described below. In some configurations, aspects of routine 750 are used to allocate storage space of a device, such as the storage device 161 of the DVR 151 of FIG. 1. Routine 750 may also apply to other storage devices on other devices, such as a storage device of a server.

The routine 750 begins at operation 751, where the content manager 105 obtains contextual data 113. The contextual data 113 is aggregated from a number of devices and/or resources. The contextual data 113 may include data describing user activity, user subscriptions, user preferences, consumption preferences and/or other information. The contextual data 113 may also describe the capabilities and/or a status of one or more devices.

In one illustrative example, the contextual data 113 may indicate that the storage device 161 of the DVR 151 has reached a threshold with respect to its storage capacity. In another example, contextual data 113 received from the on-demand resource 150 may indicate that a pricing model, e.g., a rate structure, has changed or that the user has changed their subscription status. In yet other examples, contextual data 113 received from a social network or a client computer may indicate a change in a user's consumption preference or user settings. Such data may be explicitly or implicitly provided by the user. Any type of contextual data 113 may be received in operation 751.

Next, at operation 753, the content manager 105 determines if video data is to be deleted from the storage device 161 of the DVR 151. In some configurations, the determination of whether content is to be deleted may be based on any number of factors derived from the contextual data 113. For instance, the determination of operation 753 may be based on user activity, consumption preferences, an updated status of a device, a change circumstance and/or other factors.

In one illustrative example of operation 753, the content manager 105 may determine that video data should be deleted based on the availability of new content on the on-demand resource 150. For instance, if the DVR 151 is storing the first season of a show, and the first season of the show becomes available on NETFLIX, the content manager 105 may determine that video data associated with first season may be deleted. In yet another example, a user may sign up for a subscription for AMAZON INSTANT VIDEO. In such a scenario, new program information 115 and new contextual data 113 describing the subscription may be analyzed to determine that content that is available on AMAZON Instant Video may be deleted from the storage device 161 of the DVR 151.

Operation 753 may utilize any data that indicates the existence of any changed circumstance, which may involve a change in content, pricing, viewing habits, searching habits and/or a user preference. In yet another example, the system may monitor pricing, e.g., a rate structure, of a particular show provided by an on-demand resource, and if a price for that particular show meets a threshold, the system 100 may determine that a recording of that particular show stored on the DVR 151 may be deleted. These examples are provided for illustrative purposes and are not to be construed as limiting. As will be described in more detail below, any number of changed circumstances described in the received contextual data 113 may cause the content manager 105 to delete video data from the storage device 161 of the DVR 151.

If it is determined that video data should be deleted, the routine 750 proceeds to operation 755 where the content manager 105 determines if there is an alternative resource for content items stored in the storage device 161 of the DVR 151. In some configurations, the content manager 105 analyzes the program information 115 or sends queries to one or more on-demand resources 150 to determine if at least one on-demand resource 150 shares the content items stored on the storage device 161.

With reference to the above-described example where the contextual data 113 indicates that the storage device 161 of the DVR 151 has reached a threshold with respect to its storage capacity, in operation 755, the content manager 105 may cause the DVR 151 to scan the stored video data to determine if any of the stored data is associated with content items shared by at least one on-demand resource 150. In one illustrative example, if the storage device 161 of the DVR 151 stores an episode of THE SIMPSONS, the content manager 105 may search program information 115 of a number of on-demand resources 150, such as NETFLIX and AMAZON, to see if the episode is available on an alternative resource. The system 100 may utilize a number of factors to determine if alternative content is available. For example, the system 100 may determine that alternative content is available if a particular content item meets one or more thresholds and/or conditions related to video quality, video format, available delivery methods and/or other features. For instance, based on one or more consumption preferences and/or other factors, the system 100 may determine that an alternative source for a content item is not suitable if the delivery involves commercials or does not have the ability to fast-forward through commercials. In other examples, the system 100 may determine that an alternative source for a content item is not suitable if the alternative resource does not meet a video quality standard, e.g, 1080P video, or if the alternative resource does not deliver content to a certain type of device, etc.

At operation 755, if it is determined that there is an alternative resource for a particular content item stored in the storage device 161, the routine 750 proceeds to operation 757 where the content manager 105 may instruct the DVR 151 to delete the particular content item. Next, at operation 759, the content manager 105 may obtain a link and/or other data configured to provide access to the particular content item shared by the on-demand service 151. As described above, the link or other data for providing access to the content item may be used to configure a user interface. As described above and shown in FIGS. 5 and 6, a link to on-demand content may replace a link to recorded content. In some configurations, the user interface may not show the change in the link, making the transition to on-demand content seamless and with minimal interruption to the user. After operation 759 the routine 750 terminates.

At operation 755, if it is determined that there are no alternatives for the stored data, the routine 750 proceeds to operation 760 where alternative processing of the content item is performed. Operation 755 may include any type of processing to video data associated with the content item. In some configurations, operation 760 may perform a “soft delete” on video data associated with the content item. For example, video data associated with the content item may be marked for deletion. Then later, when a suitable alternative content becomes available, the video data associated with the content item may be actually deleted at a later time.

Operation 760 may include any combination of processes, including taking no action, which would result in no video data being deleted if no suitable alternative content is available. Any type of processing may occur to modify, move, process and/or delete video data and/or data of a playlist. For example, in some configurations, the video data may be moved to another storage device, e.g., moved from a DVR to a cloud storage solution. In some configurations, video data may be compressed or otherwise processed in a manner that optimizes the usage of one or more devices. Any modification and/or processing of video data may accompanied by processing of data of a playlist as described herein. After operation 760, the routine 750 terminates.

Although FIG. 7 illustrates a configuration where the determination to delete data and the identification of alternative content items are in two operations (753 and 755), configurations combining these operations are within the scope of the present disclosure. For instance, in operation 753, the routine 750 may be configured to identify a need to delete data and identify suitable alternatives. In addition, it can be appreciated that the operations in routine 750 may be executed in any order.

FIG. 8 shows additional details of an example computer architecture 800 for a computer, such as the computing device 101 (FIG. 1), capable of executing the program components described above for providing contextually aware management of resources. Thus, the computer architecture 800 illustrated in FIG. 8 illustrates an architecture for a server computer, mobile phone, a PDA, a smart phone, a desktop computer, a netbook computer, a tablet computer, and/or a laptop computer. The computer architecture 800 may be utilized to execute any aspects of the software components presented herein.

The computer architecture 800 illustrated in FIG. 8 includes a central processing unit 802 (“CPU”), a system memory 804, including a random access memory 806 (“RAM”) and a read-only memory (“ROM”) 808, and a system bus 810 that couples the memory 804 to the CPU 802. A basic input/output system containing the basic routines that help to transfer information between elements within the computer architecture 800, such as during startup, is stored in the ROM 808. The computer architecture 800 further includes a mass storage device 812 for storing an operating system 807, and one or more application programs including, but not limited to, the web browser 810, client manager 111, and a web browser application 810, which may be used to view content data 117.

The mass storage device 812 is connected to the CPU 802 through a mass storage controller (not shown) connected to the bus 810. The mass storage device 812 and its associated computer-readable media provide non-volatile storage for the computer architecture 800. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 800.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 800. For purposes the claims, the phrase “computer storage medium,” “computer-readable storage medium” and variations thereof, does not include waves, signals, and/or other transitory and/or intangible communication media, per se.

According to various configurations, the computer architecture 800 may operate in a networked environment using logical connections to remote computers through the network 1056 and/or another network (not shown). The computer architecture 800 may connect to the network 1056 through a network interface unit 814 connected to the bus 810. It should be appreciated that the network interface unit 814 also may be utilized to connect to other types of networks and remote computer systems. The computer architecture 800 also may include an input/output controller 816 for receiving and processing input from a number of other devices, including a keyboard, mouse, or electronic stylus (not shown in FIG. 8). Similarly, the input/output controller 816 may provide output to a display screen, a printer, or other type of output device (also not shown in FIG. 8).

It should be appreciated that the software components described herein may, when loaded into the CPU 802 and executed, transform the CPU 802 and the overall computer architecture 800 from a general-purpose computing system into a special-purpose computing system customized to facilitate the functionality presented herein. The CPU 802 may be constructed from any number of transistors or other discrete circuit elements, which may individually or collectively assume any number of states. More specifically, the CPU 802 may operate as a finite-state machine, in response to executable instructions contained within the software modules disclosed herein. These computer-executable instructions may transform the CPU 802 by specifying how the CPU 802 transitions between states, thereby transforming the transistors or other discrete hardware elements constituting the CPU 802.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 800 in order to store and execute the software components presented herein. It also should be appreciated that the computer architecture 800 may include other types of computing devices, including hand-held computers, embedded computer systems, personal digital assistants, and other types of computing devices known to those skilled in the art. It is also contemplated that the computer architecture 800 may not include all of the components shown in FIG. 8, may include other components that are not explicitly shown in FIG. 8, or may utilize an architecture completely different than that shown in FIG. 8.

FIG. 9 depicts an illustrative distributed computing environment 900 capable of executing the software components described herein for providing contextually aware management of resources, among other aspects. Thus, the distributed computing environment 900 illustrated in FIG. 9 can be utilized to execute any aspects of the software components presented herein. For example, the distributed computing environment 900 can be utilized to execute aspects of the web browser 810, the content manager 105 and/or other software components described herein.

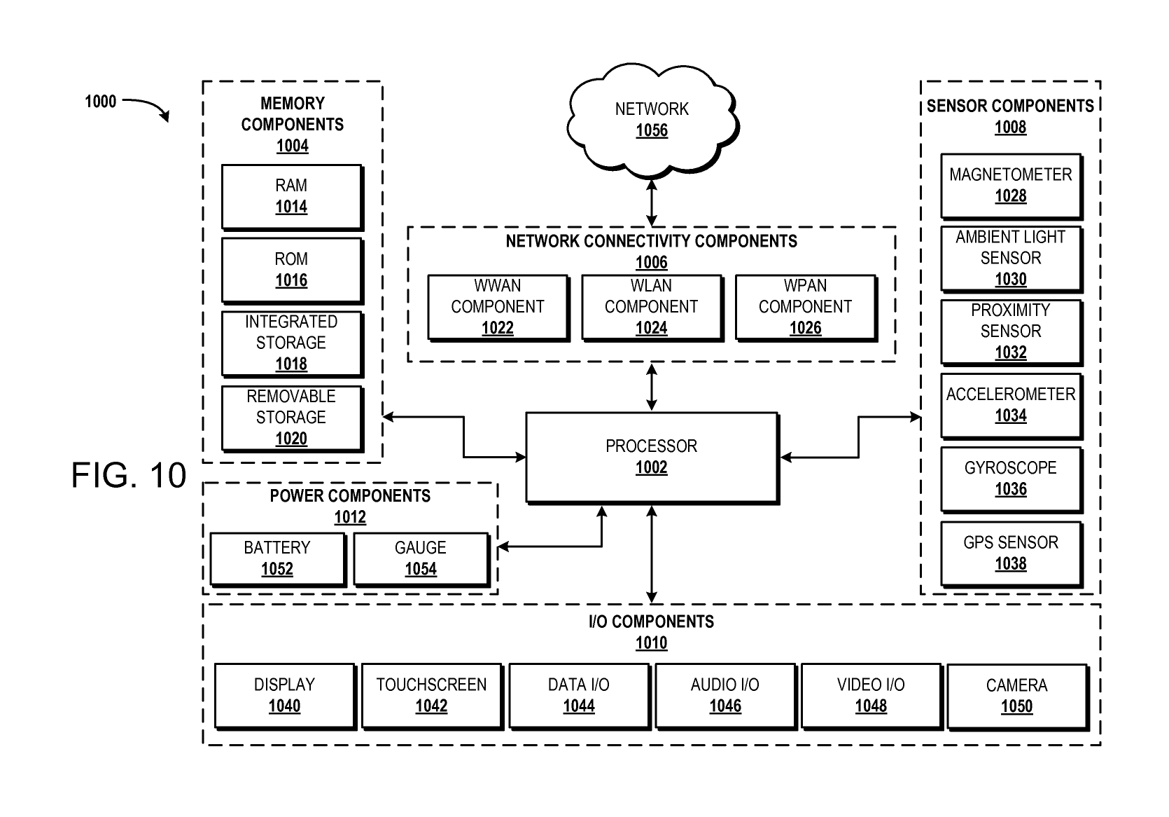

According to various implementations, the distributed computing environment 900 includes a computing environment 902 operating on, in communication with, or as part of the network 904. The network 904 may be or may include the network 1056, described above with reference to FIG. 8. The network 904 also can include various access networks. One or more client devices 906A-906N (hereinafter referred to collectively and/or generically as “clients 906”) can communicate with the computing environment 902 via the network 904 and/or other connections (not illustrated in FIG. 9). In one illustrated configuration, the clients 906 include a computing device 906A such as a laptop computer, a desktop computer, or other computing device; a slate or tablet computing device (“tablet computing device”) 906B; a mobile computing device 906C such as a mobile telephone, a smart phone, or other mobile computing device; a server computer 906D; and/or other devices 906N. It should be understood that any number of clients 906 can communicate with the computing environment 902. Two example computing architectures for the clients 906 are illustrated and described herein with reference to FIGS. 8 and 10. It should be understood that the illustrated clients 906 and computing architectures illustrated and described herein are illustrative, and should not be construed as being limited in any way.

In the illustrated configuration, the computing environment 902 includes application servers 908, data storage 910, and one or more network interfaces 912. According to various implementations, the functionality of the application servers 908 can be provided by one or more server computers that are executing as part of, or in communication with, the network 904. The application servers 908 can host various services, virtual machines, portals, and/or other resources. In the illustrated configuration, the application servers 908 host one or more virtual machines 914 for hosting applications or other functionality. According to various implementations, the virtual machines 914 host one or more applications and/or software modules for providing contextually aware management of resources. It should be understood that this configuration is illustrative, and should not be construed as being limiting in any way. The application servers 908 also host or provide access to one or more portals, link pages, Web sites, and/or other information (“Web portals”) 916.

According to various implementations, the application servers 908 also include one or more mailbox services 918 and one or more messaging services 920. The mailbox services 918 can include electronic mail (“email”) services. The mailbox services 918 also can include various personal information management (“PIM”) services including, but not limited to, calendar services, contact management services, collaboration services, and/or other services. The messaging services 920 can include, but are not limited to, instant messaging services, chat services, forum services, and/or other communication services.

The application servers 908 also may include one or more social networking services 922. The social networking services 922 can include various social networking services including, but not limited to, services for sharing or posting status updates, instant messages, links, photos, videos, and/or other information; services for commenting or displaying interest in articles, products, blogs, or other resources; and/or other services. In some configurations, the social networking services 922 are provided by or include the FACEBOOK social networking service, the LINKEDIN professional networking service, the MYSPACE social networking service, the FOURSQUARE geographic networking service, the YAMMER office colleague networking service, and the like. In other configurations, the social networking services 922 are provided by other services, sites, and/or providers that may or may not be explicitly known as social networking providers. For example, some web sites allow users to interact with one another via email, chat services, and/or other means during various activities and/or contexts such as reading published articles, commenting on goods or services, publishing, collaboration, gaming, and the like. Examples of such services include, but are not limited to, the WINDOWS LIVE service and the XBOX LIVE service from Microsoft Corporation in Redmond, Wash. Other services are possible and are contemplated.

The social networking services 922 also can include commenting, blogging, and/or micro blogging services. Examples of such services include, but are not limited to, the YELP commenting service, the KUDZU review service, the OFFICETALK enterprise micro blogging service, the TWITTER messaging service, the GOOGLE BUZZ service, and/or other services. It should be appreciated that the above lists of services are not exhaustive and that numerous additional and/or alternative social networking services 922 are not mentioned herein for the sake of brevity. As such, the above configurations are illustrative, and should not be construed as being limited in any way. According to various implementations, the social networking services 922 may host one or more applications and/or software modules for providing the functionality described herein for providing contextually aware management of resources. For instance, any one of the application servers 908 may communicate or facilitate the functionality and features described herein. For instance, a social networking application, mail client, messaging client or a browser running on a phone or any other client 906 may communicate with a networking service 922 and facilitate the functionality, even in part, described above with respect to FIG. 3A.

As shown in FIG. 9, the application servers 908 also can host other services, applications, portals, and/or other resources (“other resources”) 924. The other resources 924 can include, but are not limited to, document sharing, rendering or any other functionality. It thus can be appreciated that the computing environment 902 can provide integration of the concepts and technologies disclosed herein provided herein with various mailbox, messaging, social networking, and/or other services or resources.

As mentioned above, the computing environment 902 can include the data storage 910. According to various implementations, the functionality of the data storage 910 is provided by one or more databases operating on, or in communication with, the network 904. The functionality of the data storage 910 also can be provided by one or more server computers configured to host data for the computing environment 902. The data storage 910 can include, host, or provide one or more real or virtual datastores 926A-926N (hereinafter referred to collectively and/or generically as “datastores 926”). The datastores 926 are configured to host data used or created by the application servers 908 and/or other data. Although not illustrated in FIG. 9, the datastores 926 also can host or store web page documents, word documents, presentation documents, data structures, algorithms for execution by a recommendation engine, and/or other data utilized by any application program or another module, such as the content manager 105. Aspects of the datastores 926 may be associated with a service for storing files.

The computing environment 902 can communicate with, or be accessed by, the network interfaces 912. The network interfaces 912 can include various types of network hardware and software for supporting communications between two or more computing devices including, but not limited to, the clients 906 and the application servers 908. It should be appreciated that the network interfaces 912 also may be utilized to connect to other types of networks and/or computer systems.

It should be understood that the distributed computing environment 900 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 900 provides the software functionality described herein as a service to the clients 906. It should be understood that the clients 906 can include real or virtual machines including, but not limited to, server computers, web servers, personal computers, mobile computing devices, smart phones, and/or other devices. As such, various configurations of the concepts and technologies disclosed herein enable any device configured to access the distributed computing environment 900 to utilize the functionality described herein for providing contextually aware management of resources, among other aspects. In one specific example, as summarized above, techniques described herein may be implemented, at least in part, by the web browser application 810 of FIG. 8, which works in conjunction with the application servers 908 of FIG. 9.

Turning now to FIG. 10, an illustrative computing device architecture 1000 for a computing device that is capable of executing various software components described herein for providing contextually aware management of resources. The computing device architecture 1000 is applicable to computing devices that facilitate mobile computing due, in part, to form factor, wireless connectivity, and/or battery-powered operation. In some configurations, the computing devices include, but are not limited to, mobile telephones, tablet devices, slate devices, portable video game devices, and the like. The computing device architecture 1000 is applicable to any of the clients 906 shown in FIG. 9. Moreover, aspects of the computing device architecture 1000 may be applicable to traditional desktop computers, portable computers (e.g., laptops, notebooks, ultra-portables, and netbooks), server computers, and other computer systems, such as described herein with reference to FIG. 8. For example, the single touch and multi-touch aspects disclosed herein below may be applied to desktop computers that utilize a touchscreen or some other touch-enabled device, such as a touch-enabled track pad or touch-enabled mouse.

The computing device architecture 1000 illustrated in FIG. 10 includes a processor 1002, memory components 1004, network connectivity components 1006, sensor components 1008, input/output components 1010, and power components 1012. In the illustrated configuration, the processor 1002 is in communication with the memory components 1004, the network connectivity components 1006, the sensor components 1008, the input/output (“I/O”) components 1010, and the power components 1012. Although no connections are shown between the individuals components illustrated in FIG. 10, the components can interact to carry out device functions. In some configurations, the components are arranged so as to communicate via one or more busses (not shown).

The processor 1002 includes a central processing unit (“CPU”) configured to process data, execute computer-executable instructions of one or more application programs, and communicate with other components of the computing device architecture 1000 in order to perform various functionality described herein. The processor 1002 may be utilized to execute aspects of the software components presented herein and, particularly, those that utilize, at least in part, a touch-enabled input.

In some configurations, the processor 1002 includes a graphics processing unit (“GPU”) configured to accelerate operations performed by the CPU, including, but not limited to, operations performed by executing general-purpose scientific and/or engineering computing applications, as well as graphics-intensive computing applications such as high resolution video (e.g., 720P, 1080P, and higher resolution), video games, three-dimensional (“3D”) modeling applications, and the like. In some configurations, the processor 1002 is configured to communicate with a discrete GPU (not shown). In any case, the CPU and GPU may be configured in accordance with a co-processing CPU/GPU computing model, wherein the sequential part of an application executes on the CPU and the computationally-intensive part is accelerated by the GPU.

In some configurations, the processor 1002 is, or is included in, a system-on-chip (“SoC”) along with one or more of the other components described herein below. For example, the SoC may include the processor 1002, a GPU, one or more of the network connectivity components 1006, and one or more of the sensor components 1008. In some configurations, the processor 1002 is fabricated, in part, utilizing a package-on-package (“PoP”) integrated circuit packaging technique. The processor 1002 may be a single core or multi-core processor.

The processor 1002 may be created in accordance with an ARM architecture, available for license from ARM HOLDINGS of Cambridge, United Kingdom. Alternatively, the processor 1002 may be created in accordance with an x86 architecture, such as is available from INTEL CORPORATION of Mountain View, Calif. and others. In some configurations, the processor 1002 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 1004 include a random access memory (“RAM”) 1014, a read-only memory (“ROM”) 1016, an integrated storage memory (“integrated storage”) 1018, and a removable storage memory (“removable storage”) 1020. In some configurations, the RAM 1014 or a portion thereof, the ROM 1016 or a portion thereof, and/or some combination the RAM 1014 and the ROM 1016 is integrated in the processor 1002. In some configurations, the ROM 1016 is configured to store a firmware, an operating system or a portion thereof (e.g., operating system kernel), and/or a bootloader to load an operating system kernel from the integrated storage 1018 and/or the removable storage 1020.

The integrated storage 1018 can include a solid-state memory, a hard disk, or a combination of solid-state memory and a hard disk. The integrated storage 1018 may be soldered or otherwise connected to a logic board upon which the processor 1002 and other components described herein also may be connected. As such, the integrated storage 1018 is integrated in the computing device. The integrated storage 1018 is configured to store an operating system or portions thereof, application programs, data, and other software components described herein.

The removable storage 1020 can include a solid-state memory, a hard disk, or a combination of solid-state memory and a hard disk. In some configurations, the removable storage 1020 is provided in lieu of the integrated storage 1018. In other configurations, the removable storage 1020 is provided as additional optional storage. In some configurations, the removable storage 1020 is logically combined with the integrated storage 1018 such that the total available storage is made available as a total combined storage capacity. In some configurations, the total combined capacity of the integrated storage 1018 and the removable storage 1020 is shown to a user instead of separate storage capacities for the integrated storage 1018 and the removable storage 1020.

The removable storage 1020 is configured to be inserted into a removable storage memory slot (not shown) or other mechanism by which the removable storage 1020 is inserted and secured to facilitate a connection over which the removable storage 1020 can communicate with other components of the computing device, such as the processor 1002. The removable storage 1020 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 1004 can store an operating system. According to various configurations, the operating system includes, but is not limited to WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 1006 include a wireless wide area network component (“WWAN component”) 1022, a wireless local area network component (“WLAN component”) 1024, and a wireless personal area network component (“WPAN component”) 1026. The network connectivity components 1006 facilitate communications to and from the network 1056 or another network, which may be a WWAN, a WLAN, or a WPAN. Although only the network 1056 is illustrated, the network connectivity components 1006 may facilitate simultaneous communication with multiple networks, including the network 904 of FIG. 9. For example, the network connectivity components 1006 may facilitate simultaneous communications with multiple networks via one or more of a WWAN, a WLAN, or a WPAN.

The network 1056 may be or may include a WWAN, such as a mobile telecommunications network utilizing one or more mobile telecommunications technologies to provide voice and/or data services to a computing device utilizing the computing device architecture 1000 via the WWAN component 1022. The mobile telecommunications technologies can include, but are not limited to, Global System for Mobile communications (“GSM”), Code Division Multiple Access (“CDMA”) ONE, CDMA7000, Universal Mobile Telecommunications System (“UMTS”), Long Term Evolution (“LTE”), and Worldwide Interoperability for Microwave Access (“WiMAX”). Moreover, the network 1056 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 104 may be configured to provide voice and/or data communications with any combination of the above technologies. The network 1056 may be configured to or adapted to provide voice and/or data communications in accordance with future generation technologies.

In some configurations, the WWAN component 1022 is configured to provide dual-multi-mode connectivity to the network 1056. For example, the WWAN component 1022 may be configured to provide connectivity to the network 1056, wherein the network 1056 provides service via GSM and UMTS technologies, or via some other combination of technologies. Alternatively, multiple WWAN components 1022 may be utilized to perform such functionality, and/or provide additional functionality to support other non-compatible technologies (i.e., incapable of being supported by a single WWAN component). The WWAN component 1022 may facilitate similar connectivity to multiple networks (e.g., a UMTS network and an LTE network).

The network 1056 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 1024 is configured to connect to the network 1056 via the WI-FI access points. Such connections may be secured via various encryption technologies including, but not limited, WI-FI Protected Access (“WPA”), WPA2, Wired Equivalent Privacy (“WEP”), and the like.

The network 1056 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 1026 is configured to facilitate communications with other devices, such as peripherals, computers, or other computing devices via the WPAN.

The sensor components 1008 include a magnetometer 1028, an ambient light sensor 1030, a proximity sensor 1032, an accelerometer 1034, a gyroscope 1036, and a Global Positioning System sensor (“GPS sensor”) 1038. It is contemplated that other sensors, such as, but not limited to, temperature sensors or shock detection sensors, also may be incorporated in the computing device architecture 1000.

The magnetometer 1028 is configured to measure the strength and direction of a magnetic field. In some configurations the magnetometer 1028 provides measurements to a compass application program stored within one of the memory components 1004 in order to provide a user with accurate directions in a frame of reference including the cardinal directions, north, south, east, and west. Similar measurements may be provided to a navigation application program that includes a compass component. Other uses of measurements obtained by the magnetometer 1028 are contemplated.

The ambient light sensor 1030 is configured to measure ambient light. In some configurations, the ambient light sensor 1030 provides measurements to an application program stored within one the memory components 1004 in order to automatically adjust the brightness of a display (described below) to compensate for low-light and high-light environments. Other uses of measurements obtained by the ambient light sensor 1030 are contemplated.

The proximity sensor 1032 is configured to detect the presence of an object or thing in proximity to the computing device without direct contact. In some configurations, the proximity sensor 1032 detects the presence of a user's body (e.g., the user's face) and provides this information to an application program stored within one of the memory components 1004 that utilizes the proximity information to enable or disable some functionality of the computing device. For example, a telephone application program may automatically disable a touchscreen (described below) in response to receiving the proximity information so that the user's face does not inadvertently end a call or enable/disable other functionality within the telephone application program during the call. Other uses of proximity as detected by the proximity sensor 1032 are contemplated.

The accelerometer 1034 is configured to measure proper acceleration. In some configurations, output from the accelerometer 1034 is used by an application program as an input mechanism to control some functionality of the application program. For example, the application program may be a video game in which a character, a portion thereof, or an object is moved or otherwise manipulated in response to input received via the accelerometer 1034. In some configurations, output from the accelerometer 1034 is provided to an application program for use in switching between landscape and portrait modes, calculating coordinate acceleration, or detecting a fall. Other uses of the accelerometer 1034 are contemplated.

The gyroscope 1036 is configured to measure and maintain orientation. In some configurations, output from the gyroscope 1036 is used by an application program as an input mechanism to control some functionality of the application program. For example, the gyroscope 1036 can be used for accurate recognition of movement within a 3D environment of a video game application or some other application. In some configurations, an application program utilizes output from the gyroscope 1036 and the accelerometer 1034 to enhance control of some functionality of the application program. Other uses of the gyroscope 1036 are contemplated.

The GPS sensor 1038 is configured to receive signals from GPS satellites for use in calculating a location. The location calculated by the GPS sensor 1038 may be used by any application program that requires or benefits from location information. For example, the location calculated by the GPS sensor 1038 may be used with a navigation application program to provide directions from the location to a destination or directions from the destination to the location. Moreover, the GPS sensor 1038 may be used to provide location information to an external location-based service, such as E911 service. The GPS sensor 1038 may obtain location information generated via WI-FI, WIMAX, and/or cellular triangulation techniques utilizing one or more of the network connectivity components 1006 to aid the GPS sensor 1038 in obtaining a location fix. The GPS sensor 1038 may also be used in Assisted GPS (“A-GPS”) systems.

The I/O components 1010 include a display 1040, a touchscreen 1042, a data I/O interface component (“data I/O”) 1044, an audio I/O interface component (“audio I/O”) 1046, a video I/O interface component (“video I/O”) 1048, and a camera 1050. In some configurations, the display 1040 and the touchscreen 1042 are combined. In some configurations two or more of the data I/O component 1044, the audio I/O component 1046, and the video I/O component 1048 are combined. The I/O components 1010 may include discrete processors configured to support the various interface described below, or may include processing functionality built-in to the processor 1002.

The display 1040 is an output device configured to present information in a visual form. In particular, the display 1040 may present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 1040 is a liquid crystal display (“LCD”) utilizing any active or passive matrix technology and any backlighting technology (if used). In some configurations, the display 1040 is an organic light emitting diode (“OLED”) display. Other display types are contemplated.

The touchscreen 1042, also referred to herein as a “touch-enabled screen,” is an input device configured to detect the presence and location of a touch. The touchscreen 1042 may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some configurations, the touchscreen 1042 is incorporated on top of the display 1040 as a transparent layer to enable a user to use one or more touches to interact with objects or other information presented on the display 1040. In other configurations, the touchscreen 1042 is a touch pad incorporated on a surface of the computing device that does not include the display 1040. For example, the computing device may have a touchscreen incorporated on top of the display 1040 and a touch pad on a surface opposite the display 1040.

In some configurations, the touchscreen 1042 is a single-touch touchscreen. In other configurations, the touchscreen 1042 is a multi-touch touchscreen. In some configurations, the touchscreen 1042 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures may be implemented in software for use with the touchscreen 1042. As such, a developer may create gestures that are specific to a particular application program.

In some configurations, the touchscreen 1042 supports a tap gesture in which a user taps the touchscreen 1042 once on an item presented on the display 1040. The tap gesture may be used for various reasons including, but not limited to, opening or launching whatever the user taps. In some configurations, the touchscreen 1042 supports a double tap gesture in which a user taps the touchscreen 1042 twice on an item presented on the display 1040. The double tap gesture may be used for various reasons including, but not limited to, zooming in or zooming out in stages. In some configurations, the touchscreen 1042 supports a tap and hold gesture in which a user taps the touchscreen 1042 and maintains contact for at least a pre-defined time. The tap and hold gesture may be used for various reasons including, but not limited to, opening a context-specific menu.

In some configurations, the touchscreen 1042 supports a pan gesture in which a user places a finger on the touchscreen 1042 and maintains contact with the touchscreen 1042 while moving the finger on the touchscreen 1042. The pan gesture may be used for various reasons including, but not limited to, moving through screens, images, or menus at a controlled rate. Multiple finger pan gestures are also contemplated. In some configurations, the touchscreen 1042 supports a flick gesture in which a user swipes a finger in the direction the user wants the screen to move. The flick gesture may be used for various reasons including, but not limited to, scrolling horizontally or vertically through menus or pages. In some configurations, the touchscreen 1042 supports a pinch and stretch gesture in which a user makes a pinching motion with two fingers (e.g., thumb and forefinger) on the touchscreen 1042 or moves the two fingers apart. The pinch and stretch gesture may be used for various reasons including, but not limited to, zooming gradually in or out of a website, map, or picture.

Although the above gestures have been described with reference to the use one or more fingers for performing the gestures, other appendages such as toes or objects such as styluses may be used to interact with the touchscreen 1042. As such, the above gestures should be understood as being illustrative and should not be construed as being limiting in any way.

The data I/O interface component 1044 is configured to facilitate input of data to the computing device and output of data from the computing device. In some configurations, the data I/O interface component 1044 includes a connector configured to provide wired connectivity between the computing device and a computer system, for example, for synchronization operation purposes. The connector may be a proprietary connector or a standardized connector such as USB, micro-USB, mini-USB, or the like. In some configurations, the connector is a dock connector for docking the computing device with another device such as a docking station, audio device (e.g., a digital music player) or video device.

The audio I/O interface component 1046 is configured to provide audio input and/or output capabilities to the computing device. In some configurations, the audio I/O interface component 1046 includes a microphone configured to collect audio signals. In some configurations, the audio I/O interface component 1046 includes a headphone jack configured to provide connectivity for headphones or other external speakers. In some configurations, the audio I/O interface component 1046 includes a speaker for the output of audio signals. In some configurations, the audio I/O interface component 1046 includes an optical audio cable out.

The video I/O interface component 1048 is configured to provide video input and/or output capabilities to the computing device. In some configurations, the video I/O interface component 1048 includes a video connector configured to receive video as input from another device (e.g., a video media player such as a DVD or BLURAY player) or send video as output to another device (e.g., a monitor, a television, or some other external display). In some configurations, the video I/O interface component 1048 includes a High-Definition Multimedia Interface (“HDMI”), mini-HDMI, micro-HDMI, DisplayPort or proprietary connector to input/output video content. In some configurations, the video I/O interface component 1048 or portions thereof is combined with the audio I/O interface component 1046 or portions thereof.

The camera 1050 can be configured to capture still images and/or video. The camera 1050 may utilize a charge coupled device (“CCD”) or a complementary metal oxide semiconductor (“CMOS”) image sensor to capture images. In some configurations, the camera 1050 includes a flash to aid in taking pictures in low-light environments. Settings for the camera 1050 may be implemented as hardware or software buttons.

Although not illustrated, one or more hardware buttons may also be included in the computing device architecture 1000. The hardware buttons may be used for controlling some operational aspect of the computing device. The hardware buttons may be dedicated buttons or multi-use buttons. The hardware buttons may be mechanical or sensor-based.

The illustrated power components 1012 include one or more batteries 1052, which can be connected to a battery gauge 1054. The batteries 1052 may be rechargeable or disposable. Rechargeable battery types include, but are not limited to, lithium polymer, lithium ion, nickel cadmium and nickel metal hydride. Each of the batteries 1052 may be made of one or more cells.

The battery gauge 1054 can be configured to measure battery parameters such as current, voltage, and temperature. In some configurations, the battery gauge 1054 is configured to measure the effect of a battery's discharge rate, temperature, age and other factors to predict remaining life within a certain percentage of error. In some configurations, the battery gauge 1054 provides measurements to an application program that is configured to utilize the measurements to present useful power management data to a user. Power management data may include one or more of a percentage of battery used, a percentage of battery remaining, a battery condition, a remaining time, a remaining capacity (e.g., in watt hours), a current draw and a voltage.

The power components 1012 may also include a power connector, which may be combined with one or more of the aforementioned I/O components 1010. The power components 1012 may interface with an external power system or charging equipment via an I/O component.

The disclosure presented herein may be considered in view of the following clauses.

Clause 1: A computer (1000), comprising: a processor (1002); and a computer-readable storage medium (1004) in communication with the processor (1002), the computer-readable storage medium (1004) having computer-executable instructions stored thereupon which, when executed by the processor (1002), cause the computer (1000) to receive contextual data defining user activity, a consumption preference, a status of a device or an account status; determine if stored video data is to be deleted from or added to a digital video recorder based, at least in part, on the contextual data; if it is determined that the stored video data is to be added to the digital video recorder, select at least one content item from a playlist, cause a recording of video data associated with the at least one content item, and obtain a link configured to provide access to the recorded video data associated with the at least one content item; and if it is determined that the stored video data is to be deleted from the digital video recorder, determine if an on-demand resource shares one or more content items associated with the stored video data, and if it is determined that the on-demand resource shares the one or more content items associated with the stored video data, cause a selection of an individual content item from the one or more content items, cause the digital video recorder to delete at least a portion of the stored video data associated with the individual content item, and obtain a link configured to access streaming video data associated with the individual content item from the on-demand resource.

Clause 2: The computer of clause 1, wherein the status of the device indicates the device has exceeded a storage capacity, and wherein determining if the stored video data is to be deleted from or added to the digital video recorder is further based on the status of the device.

Clause 3: The computer of clauses 1-2, wherein the contextual data indicates a change with respect to the account status associated with the on-demand resource, and wherein determining if the stored video data is to be deleted from or added to the digital video recorder is further based on the account status.

Clause 4: The computer of clauses 1-3, wherein the contextual data indicates a change with respect to a rate structure associated with services provided by the on-demand resource, and wherein determining if the stored video data is to be deleted from or added to the digital video recorder is further based on the rate structure.

Clause 5: The computer of clauses 1-4, wherein the computer-readable storage medium has further computer-executable instructions stored thereupon which, when executed by the processor, cause the computer to integrate the link into the playlist, and wherein the link is configured to provide a control associated with the playlist to invoke a viewing session of the streaming video data from the on-demand resource.

Clause 6: The computer of clauses 1-5, wherein the contextual data indicates a rate associated with services provided by the on-demand resource, and wherein it is determined that the stored video data is to be deleted from or added to the digital video recorder if the rate meets a threshold defined by the consumption preference.

Clause 7: The computer of clauses 1-6, wherein determining if the on-demand resource shares one or more content items associated with the stored video data is based on a video quality, a delivery method, or at least one playback feature.

Clause 8: A computer-implemented example, the example comprising: receiving contextual data defining user activity, a consumption preference, a status of a device or an account status; determining if stored video data is to be deleted from a digital video recorder based, at least in part, on the contextual data; if it is determined that the stored video data is to be deleted from the digital video recorder, determining if an on-demand resource shares one or more content items associated with the stored video data, and if it is determined that the on-demand resource shares the one or more content items associated with the stored video data, causing a selection of an individual content item from the one or more content items, causing the digital video recorder to delete at least a portion of the stored video data associated with the individual content item, and obtaining a link configured to access streaming video data associated with the individual content item from the on-demand resource.

Clause 9: The example of clause 8, wherein the status of the device indicates the device has exceeded a storage capacity, and wherein determining if the stored video data is to be deleted from the digital video recorder is further based on the status of the device.

Clause 10: The example of clauses 8-9, wherein the contextual data indicates a change with respect to the account status associated with the on-demand resource, and wherein determining if the stored video data is to be deleted from the digital video recorder is further based on the account status.

Clause 11: The example of clauses 8-10, further comprising: if it is determined that the on-demand resource does not share the one or more content items associated with the stored video data, causing a selection of an individual content item from the one or more content items, causing an alternative processing, including a soft delete or a move, with at least a portion of the stored video data associated with the individual content item.

Clause 12: The example of clauses 8-11, further comprising integrating the link into the playlist, and wherein the link is configured to provide a control associated with the playlist to invoke a viewing session of the streaming video data from the on-demand resource.

Clause 13: The example of clauses 8-12, wherein the contextual data indicates a rate associated with services provided by the on-demand resource, and wherein it is determined that the stored video data is to be deleted from the digital video recorder if the rate meets a threshold defined by the consumption preference.

Clause 14: The example of clauses 8-13, wherein determining if the stored video data is to be deleted from the digital video recorder is further based on one or more conditions defined in the consumption preference.

Clause 15: A computer-readable storage medium (1004) having computer-executable instructions stored thereupon which, when executed by a computer (1000), cause the computer to: receive contextual data defining user activity, a consumption preference, a status of a device or an account status; determine if stored video data is to be deleted from a storage device based, at least in part, on the contextual data; if it is determined that the stored video data is to be deleted from the storage device, determine if an on-demand resource shares one or more content items associated with the stored video data, and if it is determined that the on-demand resource shares the one or more content items associated with the stored video data, cause a selection of an individual content item from the one or more content items, cause the storage device to delete at least a portion of the stored video data associated with the individual content item, and obtain a link configured to access streaming video data associated with the individual content item from the on-demand resource.

Clause 16: The computer-readable storage medium of clause 15, wherein the status of the device indicates the device has exceeded a storage capacity, and wherein determining if the stored video data is to be deleted from the storage device is further based on the status of the device.

Clause 17: The computer-readable storage medium of clauses 15-16, wherein the contextual data indicates a change with respect to the account status associated with the on-demand resource, and wherein determining if the stored video data is to be deleted from the storage device is further based on the account status.

Clause 18: The computer-readable storage medium of clauses 15-17, wherein the contextual data indicates a change with respect to a rate structure associated with services provided by the on-demand resource, and wherein determining if the stored video data is to be deleted from the storage device is further based on the rate structure.

Clause 19: The computer-readable storage medium of clauses 15-18, wherein the computer-readable storage medium has further computer-executable instructions stored thereupon which, when executed by the processor, cause the computer to integrate the link into the playlist, and wherein the link is configured to provide a control associated with the playlist to invoke a viewing session of the streaming video data from the on-demand resource.

Clause 20: The computer-readable storage medium of clauses 15-19, wherein the contextual data indicates a rate associated with services provided by the on-demand resource, and wherein it is determined that the stored video data is to be deleted from the storage device if the rate meets a threshold defined by the consumption preference.

Based on the foregoing, it should be appreciated that concepts and technologies have been disclosed herein that provide contextually aware management of resources. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example configurations and applications illustrated and described, and without departing from the true spirit and scope of the present invention, which is set forth in the following claims.

1. A computer, comprising:
a processor; and
a computer-readable storage medium in communication with the processor, the computer-readable storage medium having computer-executable instructions stored thereupon which, when executed by the processor, cause the computer to
receive contextual data defining user activity, a consumption preference, a status of a device or an account status;
determine when stored video data is to be deleted from or added to a digital video recorder based, at least in part, on the contextual data;
when it is determined that the stored video data is to be added to the digital video recorder,
select at least one content item from a playlist,
cause a recording of video data associated with the at least one content item, and
obtain a link providing access to the recorded video data associated with the at least one content item; and
when it is determined that the stored video data is to be deleted from the digital video recorder,
determine when an on-demand resource shares a content item associated with the stored video data,
cause the digital video recorder to delete at least a portion of the stored video data of the content item when it is determined that the on-demand resource shares the content item associated with the stored video data, and
obtain a link for accessing streaming video data of the content item from the on-demand resource.

2. The computer of claim 1, wherein the status of the device indicates the device has exceeded a storage capacity, and wherein determining when the stored video data is to be deleted from or added to the digital video recorder is further based on the status of the device.

3. The computer of claim 1, wherein the contextual data indicates a change with respect to the account status associated with the on-demand resource, and wherein determining when the stored video data is to be deleted from or added to the digital video recorder is further based on the account status.

4. The computer of claim 1, wherein the contextual data indicates a change with respect to a rate structure associated with services provided by the on-demand resource, and wherein determining when the stored video data is to be deleted from or added to the digital video recorder is further based on the rate structure.

5. The computer of claim 1, wherein the computer-readable storage medium has further computer-executable instructions stored thereupon which, when executed by the processor, cause the computer to integrate the link into the playlist, and wherein the link provides a control associated with the playlist to invoke a viewing session of the streaming video data from the on-demand resource.

6. The computer of claim 1, wherein the contextual data indicates a rate associated with services provided by the on-demand resource, and wherein it is determined that the stored video data is to be deleted from or added to the digital video recorder when the rate meets a threshold defined by the consumption preference.

7. The computer of claim 1, wherein determining when the on-demand resource shares one or more content items associated with the stored video data is based on a permission, a video quality, a delivery method, or at least one playback feature.

8. A computer-implemented method, the method comprising:
receiving contextual data defining user activity, a consumption preference, a status of a device or an account status;
determining when stored video data is to be deleted from a digital video recorder based, at least in part, on the contextual data;
when it is determined that the stored video data is to be deleted from the digital video recorder,
determining when an on-demand resource shares one or more content items associated with the stored video data, and
when it is determined that the on-demand resource shares the one or more content items associated with the stored video data,
causing a selection of an individual content item from the one or more content items,
causing the digital video recorder to delete at least a portion of the stored video data associated with the individual content item, and
obtaining a link for accessing streaming video data associated with the individual content item from the on-demand resource.

9. The computer-implemented method of claim 8, wherein the status of the device indicates the device has exceeded a storage capacity, and wherein determining when the stored video data is to be deleted from the digital video recorder is further based on the status of the device.

10. The computer-implemented method of claim 8, wherein the contextual data indicates a change with respect to the account status associated with the on-demand resource, and wherein determining when the stored video data is to be deleted from the digital video recorder is further based on the account status.

11. The computer-implemented method of claim 8, further comprising:
when it is determined that the on-demand resource does not share the one or more content items associated with the stored video data,
causing a selection of the individual content item from the one or more content items,
causing an alternative processing, including a soft delete or a move, with at least a portion of the stored video data associated with the individual content item.

12. The computer-implemented method of claim 8, further comprising integrating the link into the playlist, and wherein the link provides a control associated with the playlist to invoke a viewing session of the streaming video data from the on-demand resource.

13. The computer-implemented method of claim 8, wherein the contextual data indicates a rate associated with services provided by the on-demand resource, and wherein it is determined that the stored video data is to be deleted from the digital video recorder when the rate meets a threshold defined by the consumption preference.

14. The computer-implemented method of claim 8, wherein determining when the stored video data is to be deleted from the digital video recorder is further based on one or more conditions defined in the consumption preference.

15. A computer-readable storage medium having computer-executable instructions stored thereupon which, when executed by a computer, cause the computer to:
receive contextual data defining user activity, a consumption preference, a status of a device or an account status;
determine when stored video data is to be deleted from a storage device based, at least in part, on the contextual data;
when it is determined that the stored video data is to be deleted from the storage device,
determine when an on-demand resource shares one or more content items associated with the stored video data, and
cause a selection of an individual content item from the one or more content items, when it is determined that the on-demand resource shares the one or more content items associated with the stored video data,
cause the storage device to delete at least a portion of the stored video data associated with the individual content item, when it is determined that the on-demand resource shares the one or more content items associated with the stored video data, and
obtain a link for accessing streaming video data associated with the individual content item from the on-demand resource, when it is determined that the on-demand resource shares the one or more content items associated with the stored video data.

16. The computer-readable storage medium of claim 15, wherein the status of the device indicates the device has exceeded a storage capacity, and wherein determining when the stored video data is to be deleted from the storage device is further based on the status of the device.

17. The computer-readable storage medium of claim 15, wherein the contextual data indicates a change with respect to the account status associated with the on-demand resource, and wherein determining when the stored video data is to be deleted from the storage device is further based on the account status.

18. The computer-readable storage medium of claim 15, wherein the contextual data indicates a change with respect to a rate structure associated with services provided by the on-demand resource, and wherein determining when the stored video data is to be deleted from the storage device is further based on the rate structure.

19. The computer-readable storage medium of claim 15, wherein the computer-readable storage medium has further computer-executable instructions stored thereupon which, when executed by the processor, cause the computer to integrate the link into the playlist, and wherein the link provides a control associated with the playlist to invoke a viewing session of the streaming video data from the on-demand resource.

20. The computer-readable storage medium of claim 15, wherein the contextual data indicates a rate associated with services provided by the on-demand resource, and wherein it is determined that the stored video data is to be deleted from the storage device when the rate meets a threshold defined by the consumption preference.
